(19) United States
(12) Patent Application Publication
(10) Pub. No.: US 2025/0056402 A1
(43) Pub. Date: Feb. 13, 2025

(54) CONDITIONAL ACCESS TO A CELL OF A SECONDARY CELL GROUP

(71) Applicant: Nokia Technologies Oy, Espoo (FI)

(72) Inventors: Ayaz AHMED, Bangalore (IN); Umur KARABULUT, Munich (DE); Krzysztof KORDYBACH, Wroclaw (PL); Srinivasan SELVAGANAPATHY, Bangalore (IN)

(21) Appl. No.: 18/784,652

(22) Filed: Jul. 25, 2024

(30) Foreign Application Priority Data
Aug. 10, 2023 (IN) 202341053795

(51) Int. Cl. H04W 48/20; H04W 48/16

(52) U.S. Cl. CPC H04W 48/20; H04W 48/16

(57) ABSTRACT

Certain examples of the present disclosure relate to an apparatus (120_1) comprising: means for sending (301), to a User Equipment, UE, (110), first conditional re-configuration information (302) for enabling the UE to access a cell of a Secondary Cell Group, SCG, (120_21) upon a first condition to access the cell of the SCG being met; means for sending (303), to the UE, second conditional re-configuration information (304) for enabling the UE to access a cell of another SCG (120_22) upon a second condition to access the cell of the another SCG being met; means for receiving (306), from the UE, first information (307) indicating that the first condition has been met; means for determining (308) whether to delay the cell of the SCG triggering a path switch; means for sending (309), to the cell of the SCG, a first indication (310) to delay triggering the path switch, wherein the first indication is sent based at least in part on the determination; means for receiving (313), from the UE, second information (314) indicating that the second condition has been met; means for determining (315) whether to abort the cell of the SCG triggering the path switch; and means sending (316), to the cell of the SCG, a second indication (317) to abort triggering the path switch, wherein the second indication is sent based at least in part on the determination whether to abort triggering the path switch.

### TECHNOLOGICAL FIELD

Examples of the present disclosure relate to apparatuses, methods and computer programs for enabling conditional access to a cell of a Secondary Cell Group, SCG.

### BACKGROUND

Conventional procedures for enabling conditional access to a cell of a Secondary Cell Group (such as Conditional Primary Secondary Cell, PSCell, Additions, CPA, and Conditional PSCell Changes, CPC) are not always optimal. In some circumstances, it may be desirable to improve conditional access to a cell of a SCG (such as enhance procedures for PSCell additions and/or changes). In some circumstances, it may be desirable to reduce signaling overhead involved in conditional access to a cell of a SCG.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising:
means for sending, to a User Equipment, UE, first conditional re-configuration information for enabling the UE to access a cell of a Secondary Cell Group, SCG, upon a first condition to access the cell of the SCG being met;
means for sending, to the UE, second conditional re-configuration information for enabling the UE to access a cell of another SCG upon a second condition to access the cell of the another SCG being met;
means for receiving, from the UE, first information indicating that the first condition has been met;
means for determining whether to delay the cell of the SCG triggering a path switch;
means for sending, to the cell of the SCG, a first indication to delay triggering the path switch, wherein the first indication is sent based at least in part on the determination;
means for receiving, from the UE, second information indicating that the second condition has been met;
means for determining whether to abort the cell of the SCG triggering the path switch; and
means sending, to the cell of the SCG, a second indication to abort triggering the path switch, wherein the second indication is sent based at least in part on the determination whether to abort triggering the path switch.

According to various, but not necessarily all, examples of the disclosure there is provided a method comprising:
sending, to a User Equipment, UE, first conditional re-configuration information for enabling the UE to access a cell of a Secondary Cell Group, SCG, upon a first condition to access the cell of the SCG being met;
sending, to the UE, second conditional re-configuration information for enabling the UE to access a cell of another SCG upon a second condition to access the cell of the another SCG being met;
receiving, from the UE, first information indicating that the first condition has been met;
determining whether to delay the cell of the SCG triggering a path switch;
sending, to the cell of the SCG, a first indication to delay triggering the path switch, wherein the first indication is sent based at least in part on the determination;
receiving, from the UE, second information indicating that the second condition has been met;
determining whether to abort the cell of the SCG triggering the path switch; and
sending, to the cell of the SCG, a second indication to abort triggering the path switch, wherein the second indication is sent based at least in part on the determination whether to abort triggering the path switch.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided a computer program comprising instructions, which when executed by an apparatus, cause the apparatus to perform:
sending, to a User Equipment, UE, first conditional re-configuration information for enabling the UE to access a cell of a Secondary Cell Group, SCG, upon a first condition to access the cell of the SCG being met;
sending, to the UE, second conditional re-configuration information for enabling the UE to access a cell of another SCG upon a second condition to access the cell of the another SCG being met;
receiving, from the UE, first information indicating that the first condition has been met;
determining whether to delay the cell of the SCG triggering a path switch;
sending, to the cell of the SCG, a first indication to delay triggering the path switch, wherein the first indication is sent based at least in part on the determination;
receiving, from the UE, second information indicating that the second condition has been met;
determining whether to abort the cell of the SCG triggering the path switch; and
sending, to the cell of the SCG, a second indication to abort triggering the path switch, wherein the second indication is sent based at least in part on the determination whether to abort triggering the path switch.

According to various, but not necessarily all, examples of the disclosure there is provided an apparatus comprising:
at least one processor; and
at least one memory storing instructions that, when executed by the at least one processor, cause the apparatus at least to:
   send, to a User Equipment, UE, first conditional re-configuration information for enabling the UE to access a cell of a Secondary Cell Group, SCG, upon a first condition to access the cell of the SCG being met;
   send, to the UE, second conditional re-configuration information for enabling the UE to access a cell of another SCG upon a second condition to access the cell of the another SCG being met;
   receive, from the UE, first information indicating that the first condition has been met;
   determine whether to delay the cell of the SCG triggering a path switch;
   send, to the cell of the SCG, a first indication to delay triggering the path switch, wherein the first indication is sent based at least in part on the determination;
   receive, from the UE, second information indicating that the second condition has been met;
   determine whether to abort the cell of the SCG triggering the path switch; and
   send, to the cell of the SCG, a second indication to abort triggering the path switch, wherein the second indication is sent based at least in part on the determination whether to abort triggering the path switch.

According to various, but not necessarily all, examples of the disclosure there is provided a non-transitory computer readable medium encoded with instructions that, when executed by at least one processor, causes at least the following to be performed:
send, to a User Equipment, UE, first conditional re-configuration information for enabling the UE to access a cell of a Secondary Cell Group, SCG, upon a first condition to access the cell of the SCG being met;
send, to the UE, second conditional re-configuration information for enabling the UE to access a cell of another SCG upon a second condition to access the cell of the another SCG being met;
receive, from the UE, first information indicating that the first condition has been met;
determine whether to delay the cell of the SCG triggering a path switch;
send, to the cell of the SCG, a first indication to delay triggering the path switch, wherein the first indication is sent based at least in part on the determination;
receive, from the UE, second information indicating that the second condition has been met;
determine whether to abort the cell of the SCG triggering the path switch; and
send, to the cell of the SCG, a second indication to abort triggering the path switch, wherein the second indication is sent based at least in part on the determination whether to abort triggering the path switch.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function, or any instructions stored in at least one memory that, when executed by at least one processor, cause an apparatus to perform that function.

In some but not necessarily all examples, determining whether to abort triggering the path switch is based at least in part on when the first indication was sent and when the second information was received.

In some but not necessarily all examples, the first indication comprises an indication of a delay time.

In some but not necessarily all examples, determining whether to abort triggering the path switch is based at least in part on a determination that a difference between the time the first indication was sent and the time the second information was received is less than the delay time.

In some but not necessarily all examples, the apparatus further comprises means for receiving, from the UE, a third indication to delay triggering the path switch; and the determination whether to delay the cell of the SCG from triggering a path switch is based at least in part on the third indication.

In some but not necessarily all examples, the third indication is indicative of an evaluation by the UE of at least one of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

In some but not necessarily all examples, the first conditional re-configuration information comprises at least one of the following:
an indication for the UE to send, to the apparatus, the third indication;
information for configuring the UE to evaluate the third indication;
one or more criteria for use by the UE to evaluate the third indication; and
one of more thresholds for use by the UE to evaluate the third indication.

In some but not necessarily all examples, the third indication is at one of the following:
a flag in a received message;
received in a Radio Resource Control, RRC, message;
received in an RRC connection reconfiguration complete message; and
received after the UE has determined that the first condition has been met.

In some but not necessarily all examples, the apparatus further comprises means for receiving, from the UE, one or more measurements of signals from one or more Secondary Cell Groups; and wherein the determination whether to delay the cell of the SCG from triggering the path switch is based at least in part on the received one or more measurements.

In some but not necessarily all examples, the apparatus further comprises means for evaluating, based at least in part on the one or more measurements of signals, at least one of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

In some but not necessarily all examples, the determination whether to delay the cell of the SCG from triggering the path switch is based at least in part on the evaluation.

In some but not necessarily all examples, the first conditional re-configuration information comprises at least one of the following:
information for configuring the UE to perform and/or report the one or more measurements of signals;
one or more criteria for use by the UE in performing and/or reporting the one or more measurements of signals;
one or more identifiers of one or more cells of the one or more Secondary Cell Groups, SCGs, whose signals are to be measured;
one or more group identifiers of the one or more Secondary Cell Groups, SCGs, whose signals are to be measured;
information for configuring the UE to perform one or more inter Secondary Cell Group, SCG, measurements; and
an indication for the UE to send, to the apparatus, the one or more measurements of signals from one or more SCGs.

In some but not necessarily all examples, the one or more measurements of signals are received in at one of the following:
a Radio Resource Control, RRC, message;
a layer 3 measurement report;
an RRC connection reconfiguration complete message; and
a SN RRC reconfiguration complete message.

In some but not necessarily all examples, the apparatus further comprises means for determining third information indicative of at least one of the following:
a configured scenario;
a characteristic of a cell boarder of a RAN node;
network coverage, cell coverage, and/or a coverage gap.

In some but not necessarily all examples, the apparatus further comprises means for evaluating, based at least in part on the third information, at least one or more of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

In some but not necessarily all examples, the determination whether to delay the cell of the SCG from triggering a path switch is based at least in part on the evaluation.

In some but not necessarily all examples, the first and/or second conditional re-configuration information comprises at least one of the following:
Conditional Primary Secondary Cell, PSCell, Addition, CPA, configuration information;
Conditional PSCell Change, CPC, configuration information;
Conditional PSCell, Addition or Change, CPAC, configuration information; Selective Activation of CPAC, S-CPAC, configuration information; and
CPAC configuration information with selective activation of a Secondary Cell Group, SCG, cell.

In some but not necessarily all examples, the first condition to access the cell of the SCG and/or the second condition to access a cell of another SCG comprises at least one of the following:
a first and/or second execution condition for adding the cell of the SCG and/or the cell of the another SCG respectively;
a first and/or second execution condition for changing to the cell of the SCG and/or the cell of the another SCG respectively; and
a first and/or second execution condition of a CPC candidate PSCell.

In some but not necessarily all examples, the first information indicating that the first condition has been met comprises at least one of the following:
a Radio Resource Control message;
an RRC Connection Reconfiguration complete message.

In some but not necessarily all examples, the first indication is sent via at least one of the following:
a Radio Resource Control message;
an SN RRC Reconfiguration Complete message.

In some but not necessarily all examples, the second indication is sent via at least one of:
an Xn User plane, Xn-U, interface; and
an Xn-U Address Indication message.

In some but not necessarily all examples, the apparatus is configured as a Master Node, MN, to the UE, wherein the UE is operating in a Multi Connectivity, MC, mode and is in an established connection with the MN and a source Secondary Node, SN.

According to at least some examples of the disclosure there is provided an apparatus comprising:
means for receiving, from a cell of a Master Cell Group, MCG, first conditional re-configuration information for enabling the apparatus to access a cell of a Secondary Cell Group, SCG, upon a first condition to access the cell of the SCG being met;
means for receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
means for receiving, from the cell of the MCG, second conditional re-configuration information for enabling the apparatus to access a cell of another SCG upon a second condition to access the cell of the another SCG being met;
means for determining whether the first condition has been met;
means for sending, to the cell of the MCG, first information indicating that the first condition has been met;
means for evaluating, responsive to receipt of the configuration information, whether to delay triggering the path switch; and
means for sending, to the cell of the MCG, and based at least in part on the evaluation, the indication to delay triggering the path switch.

According to various, but not necessarily all, examples of the disclosure there is provided a method comprising:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
evaluating, responsive to receipt of the configuration information, whether to delay triggering the path switch; and
sending, to the cell of the MCG, and based at least in part on the evaluation, the indication to delay triggering the path switch.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided a computer program comprising instructions, which when executed by an apparatus, cause the apparatus to perform:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
evaluating, responsive to receipt of the configuration information, whether to delay triggering the path switch; and
sending, to the cell of the MCG, and based at least in part on the evaluation, the indication to delay triggering the path switch.

According to various, but not necessarily all, examples of the disclosure there is provided an apparatus comprising:
at least one processor; and
at least one memory storing instructions that, when executed by the at least one processor, cause the apparatus at least to:
   receive, from a cell of a Master Cell Group, MCG, first conditional re-configuration information for enabling the apparatus to access a cell of a Secondary Cell Group, SCG, upon a first condition to access the cell of the SCG being met;
   receive, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
   receive, from the cell of the MCG, second conditional re-configuration information for enabling the apparatus to access a cell of another SCG upon a second condition to access the cell of the another SCG being met;
   determine whether the first condition has been met;
   send, to the cell of the MCG, first information indicating that the first condition has been met;
   evaluate, responsive to receipt of the configuration information, whether to delay triggering the path switch; and
   send, to the cell of the MCG, and based at least in part on the evaluation, the indication to delay triggering the path switch.

According to various, but not necessarily all, examples of the disclosure there is provided a non-transitory computer readable medium encoded with instructions that, when executed by at least one processor, causes at least the following to be performed:
receive, from a cell of a Master Cell Group, MCG, first conditional re-configuration information for enabling the apparatus to access a cell of a Secondary Cell Group, SCG, upon a first condition to access the cell of the SCG being met;
receive, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
receive, from the cell of the MCG, second conditional re-configuration information for enabling the apparatus to access a cell of another SCG upon a second condition to access the cell of the another SCG being met;
determine whether the first condition has been met;
send, to the cell of the MCG, first information indicating that the first condition has been met;
evaluate, responsive to receipt of the configuration information, whether to delay triggering the path switch; and
send, to the cell of the MCG, and based at least in part on the evaluation, the indication to delay triggering the path switch.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function, or any instructions stored in at least one memory that, when executed by at least one processor, cause an apparatus to perform that function.

In some but not necessarily all examples, the configuration information further comprises at least one of the following:
one or more criteria for use by the apparatus to evaluate an indication to delay triggering a path switch the indication; and
one of more thresholds for use by the apparatus to evaluate an indication to delay triggering the path switch.

In some but not necessarily all examples, evaluating whether to delay triggering the path switch is based at least in part on evaluating at least one of the following:
whether an expected time duration of access, by the apparatus, to the cell of the SCG is less than a threshold amount of time;
whether access, by the apparatus, to the cell of the SCG is expected to be a Short Stay, SS, access; and
whether access, by the apparatus, to the cell of the SCG is expected to be a Ping-Pong, PP, access.

In some but not necessarily all examples, the indication is indicative of an evaluation by the apparatus of at least one of the following:
whether an expected time duration of access, by the apparatus, to the cell of the SCG is less than a threshold amount of time;
whether access, by the apparatus, to the cell of the SCG is expected to be a Short Stay, SS, access; and
whether access, by the apparatus, to the cell of the SCG is expected to be a Ping-Pong, PP, access.

In some but not necessarily all examples, the indication is at one of the following:
a flag in a message sent to the cell of the Master Cell Group, MCG;
sent in a Radio Resource Control, RRC, message;
sent in an RRC connection reconfiguration complete message; and
sent after the apparatus has determined that the first condition has been met.

In some but not necessarily all examples, the apparatus is a User Equipment, UE, configured for operation in a Multi Connectivity, MC, mode, and wherein the UE is in an established connection with a Master Node, MN, and a source Secondary Node, SN.

According to at least some examples of the disclosure there is provided an apparatus comprising:
means for receiving, from a cell of a Master Cell Group, MCG, first conditional re-configuration information for enabling the apparatus to access a cell of a Secondary Cell Group, SCG, upon a first condition to access the cell of the SCG being met;
means for receiving, from the cell of the MCG, configuration information for configuring the apparatus measure and report one or more measurements of signals from one or more SCGs for use by the cell of the MCG to determine whether to delay the cell of the SCG from triggering a path switch;
means for receiving, from the cell of the MCG, second conditional re-configuration information for enabling the apparatus to access a cell of another SCG upon a second condition to access the cell of the another SCG being met;
means for determining whether the first condition has been met;
means for sending, to the cell of the MCG, first information indicating that the first condition has been met;
means for measuring one or more measurements of signals from the one or more SCGs in accordance with the configuration information;
means for sending, to the cell of the MCG, the one or more measurements for use by the cell of the MCG to determine whether to delay the cell of the SCG from triggering a path switch.

According to various, but not necessarily all, examples of the disclosure there is provided a method comprising:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus measure and report one or more measurements of signals from one or more SCGs for use by the cell of the MCG to determine whether to delay the cell of the SCG from triggering a path switch;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
measuring one or more measurements of signals from the one or more SCGs in accordance with the configuration information;
sending, to the cell of the MCG, the one or more measurements for use by the cell of the MCG to determine whether to delay the cell of the SCG from triggering a path switch.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided a computer program comprising instructions, which when executed by an apparatus, cause the apparatus to perform:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus measure and report one or more measurements of signals from one or more SCGs for use by the cell of the MCG to determine whether to delay the cell of the SCG from triggering a path switch;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
measuring one or more measurements of signals from the one or more SCGs in accordance with the configuration information;
sending, to the cell of the MCG, the one or more measurements for use by the cell of the MCG to determine whether to delay the cell of the SCG from triggering a path switch.

According to various, but not necessarily all, examples of the disclosure there is provided an apparatus comprising:
at least one processor; and
at least one memory storing instructions that, when executed by the at least one processor, cause the apparatus at least to:
   receive, from a cell of a Master Cell Group, MCG, first conditional re-configuration information for enabling the apparatus to access a cell of a Secondary Cell Group, SCG, upon a first condition to access the cell of the SCG being met;
   receive, from the cell of the MCG, configuration information for configuring the apparatus measure and report one or more measurements of signals from one or more SCGs for use by the cell of the MCG to determine whether to delay the cell of the SCG from triggering a path switch;
   receive, from the cell of the MCG, second conditional re-configuration information for enabling the apparatus to access a cell of another SCG upon a second condition to access the cell of the another SCG being met;
   determine whether the first condition has been met;
   send, to the cell of the MCG, first information indicating that the first condition has been met;
   measure one or more measurements of signals from the one or more SCGs in accordance with the configuration information;
   send, to the cell of the MCG, the one or more measurements for use by the cell of the MCG to determine whether to delay the cell of the SCG from triggering a path switch.

According to various, but not necessarily all, examples of the disclosure there is provided a non-transitory computer readable medium encoded with instructions that, when executed by at least one processor, causes at least the following to be performed:
receive, from a cell of a Master Cell Group, MCG, first conditional re-configuration information for enabling the apparatus to access a cell of a Secondary Cell Group, SCG, upon a first condition to access the cell of the SCG being met;
receive, from the cell of the MCG, configuration information for configuring the apparatus measure and report one or more measurements of signals from one or more SCGs for use by the cell of the MCG to determine whether to delay the cell of the SCG from triggering a path switch;
receive, from the cell of the MCG, second conditional re-configuration information for enabling the apparatus to access a cell of another SCG upon a second condition to access the cell of the another SCG being met;
determine whether the first condition has been met;
send, to the cell of the MCG, first information indicating that the first condition has been met;
measure one or more measurements of signals from the one or more SCGs in accordance with the configuration information;
send, to the cell of the MCG, the one or more measurements for use by the cell of the MCG to determine whether to delay the cell of the SCG from triggering a path switch.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function, or any instructions stored in at least one memory that, when executed by at least one processor, cause an apparatus to perform that function.

In some but not necessarily all examples, the configuration information further comprises at least one of the following:
one or more criteria for use by the apparatus in performing and/or reporting the one or more measurements of signals;
one or more identifiers of one or more cells of one or more Secondary Cell Groups, SCGs, whose signals are to be measured;
one or more group identifiers of the one or more Secondary Cell Groups, SCGs, whose signals are to be measured; and
information for configuring the apparatus to perform and report one or more inter Secondary Cell Group, SCG, measurements.

In some but not necessarily all examples, the one or more measurements of signals are sent in at one of the following:
a Radio Resource Control, RRC, message;
a layer 3 measurement report;
an RRC connection reconfiguration complete message; and
a SN RRC reconfiguration complete message.

In some but not necessarily all examples, the apparatus is a User Equipment, UE, configured for operation in a Multi Connectivity, MC, mode, and wherein the UE is in an established connection with a Master Node, MN, and a source Secondary Node, SN.

According to at least some examples of the disclosure there is provided an apparatus comprising:
means for receiving, from a cell of a Master Cell Group, MCG, reconfiguration information for configuring the apparatus as a candidate cell of a Secondary Cell Group, SCG;
means for receiving, from the cell of the MCG, information indicative of a User Equipment, UE, selecting the candidate cell of the SCG; and
means for determining to delay triggering a path switch;
means for delaying the triggering of the path switch, wherein delaying the triggering of the path switch is based at least in part on the determination to delay triggering the path switch;
means for determining to abort triggering the path switch; and
means for aborting the triggering of the path switch, wherein aborting the triggering of the path switch is based at least in part on the determination to abort triggering the path switch.

According to various, but not necessarily all, examples of the disclosure there is provided a method comprising:
receiving, from a cell of a Master Cell Group, MCG, reconfiguration information for configuring the apparatus as a candidate cell of a Secondary Cell Group, SCG;
receiving, from the cell of the MCG, information indicative of a User Equipment, UE, selecting the candidate cell of the SCG; and
determining to delay triggering a path switch;
delaying the triggering of the path switch, wherein delaying the triggering of the path switch is based at least in part on the determination to delay triggering the path switch;
determining to abort triggering the path switch; and
aborting the triggering of the path switch, wherein aborting the triggering of the path switch is based at least in part on the determination to abort triggering the path switch.

According to various, but not necessarily all, examples of the disclosure there is provided a chipset comprising processing circuitry configured to perform the above-mentioned method.

According to various, but not necessarily all, examples of the disclosure there is provided a module, circuitry, device and/or system comprising means for performing the above-mentioned method.

According to various, but not necessarily all, examples of the disclosure there is provided a computer program comprising instructions, which when executed by an apparatus, cause the apparatus to perform:
receiving, from a cell of a Master Cell Group, MCG, reconfiguration information for configuring the apparatus as a candidate cell of a Secondary Cell Group, SCG;
receiving, from the cell of the MCG, information indicative of a User Equipment, UE, selecting the candidate cell of the SCG; and
determining to delay triggering a path switch;
delaying the triggering of the path switch, wherein delaying the triggering of the path switch is based at least in part on the determination to delay triggering the path switch;
determining to abort triggering the path switch; and
aborting the triggering of the path switch, wherein aborting the triggering of the path switch is based at least in part on the determination to abort triggering the path switch.

According to various, but not necessarily all, examples of the disclosure there is provided an apparatus comprising:
at least one processor; and
at least one memory storing instructions that, when executed by the at least one processor, cause the apparatus at least to:
   receive, from a cell of a Master Cell Group, MCG, reconfiguration information for configuring the apparatus as a candidate cell of a Secondary Cell Group, SCG;
   receive, from the cell of the MCG, information indicative of a User Equipment, UE, selecting the candidate cell of the SCG; and
   determine to delay triggering a path switch;
   delay the triggering of the path switch, wherein delaying the triggering of the path switch is based at least in part on the determination to delay triggering the path switch;
   determine to abort triggering the path switch; and
   abort the triggering of the path switch, wherein aborting the triggering of the path switch is based at least in part on the determination to abort triggering the path switch.

According to various, but not necessarily all, examples of the disclosure there is provided a non-transitory computer readable medium encoded with instructions that, when executed by at least one processor, causes at least the following to be performed:
receive, from a cell of a Master Cell Group, MCG, reconfiguration information for configuring the apparatus as a candidate cell of a Secondary Cell Group, SCG;
receive, from the cell of the MCG, information indicative of a User Equipment, UE, selecting the candidate cell of the SCG; and
determine to delay triggering a path switch;
delay the triggering of the path switch, wherein delaying the triggering of the path switch is based at least in part on the determination to delay triggering the path switch;
determine to abort triggering the path switch; and
abort the triggering of the path switch, wherein aborting the triggering of the path switch is based at least in part on the determination to abort triggering the path switch.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function, or any instructions stored in at least one memory that, when executed by at least one processor, cause an apparatus to perform that function.

In some but not necessarily all examples, the apparatus further comprises means for receiving, from the cell of the MCG, an indication to delay triggering the path switch; and determining to delay triggering the path switch is based at least in part on the received indication.

In some but not necessarily all examples, the apparatus automatically determines to delay triggering the path switch.

In some but not necessarily all examples, the apparatus further comprises means for receiving, from the cell of the MCG, an indication to abort triggering the path switch; and determining to abort triggering the path switch is based at least in part on the received indication.

In some but not necessarily all examples, the apparatus is configured as a target Secondary Node, SN, for the UE, wherein the UE is operating in a Multi Connectivity, MC, mode and is in an established connection with a Master Node, MN, and a source SN.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIG. 3 shows another example of the subject matter described herein;

FIG. 4 shows another example of the subject matter described herein;

FIG. 5 shows another example of the subject matter described herein;

FIG. 6 shows another example of the subject matter described herein;

FIG. 7 shows another example of the subject matter described herein; and

FIG. 8 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### Abbreviations/Definitions

3GPP 3rd Generation Partnership Project
5G 5th Generation
5GC 5G Core
6G 6th Generation
AMF Access and Mobility Management Function
CPA Conditional PSCell Addition
CPAC Conditional PSCell Addition and/or Change
CPC Conditional PSCell Change
DC Dual Connectivity
DL Downlink
gNB 5G/NR base station
MCG Master Cell Group
MN Master Node
NG Next Generation
NR New Radio
NR-DC New Radio Dual Connectivity
PCell Primary Cell
PSCell Primary Secondary Cell
PP Ping Pong
RACH Random Access Channel
RAN Radio Access Network
RRC Radio Resource Control
SCG Secondary Cell Group
S-CPAC Selective Activation of Conditional PSCell Addition and/or Change
SN Secondary Node
SS Short Stay
S-SN Source Secondary Node
T-SN Target Secondary Node
UE User Equipment
UPF User Plane Function

### DETAILED DESCRIPTION

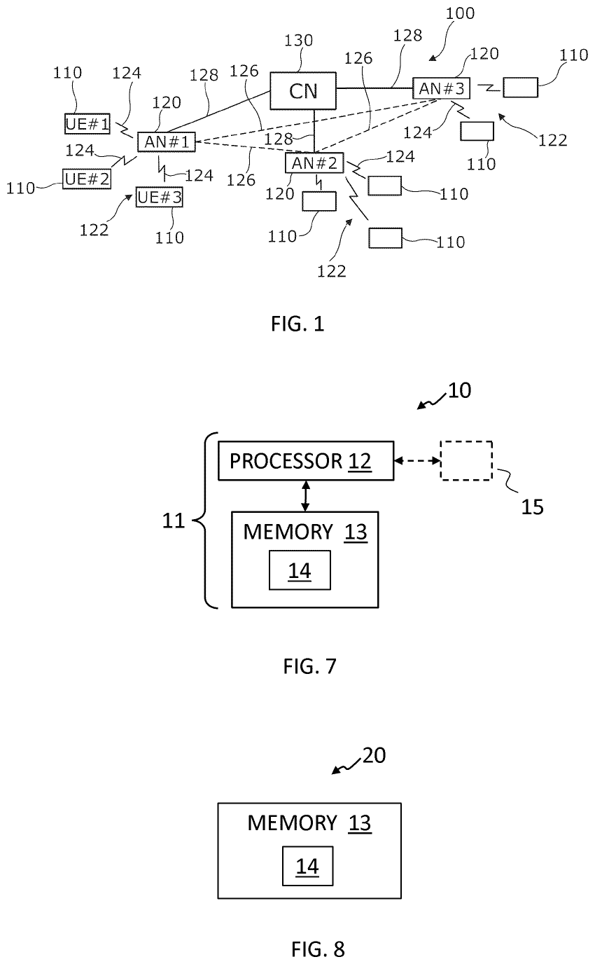

FIG. 1 schematically illustrates an example of a network 100 suitable for use with examples of the present disclosure. The network (also referred to as NW) comprises a plurality of network nodes including: terminal nodes 110 (also referred to as User Equipment, UE), access nodes 120 (also referred to as Radio Access Network, RAN, nodes, or base stations), and one or more core network nodes 130. The terminal nodes 110 and access nodes 120 communicate with each other. The one or more core network nodes 130 may, in some but not necessarily all examples, communicate with each other. The one or more access nodes 120 may, in some but not necessarily all examples, communicate with each other.

The network 100 is in this example a radio telecommunications network, i.e. a RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 may be a New Radio, NR, network of the Third Generation Partnership Project, 3GPP, and its fifth generation, 5G, technology. In other examples, the network 100 may be a network beyond 5G, for example a next generation (i.e. sixth generation, 6G) Radio Network that is currently under development (i.e. an evolution of the NR network and its 5G technology).

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or Next Generation, NG, interfaces).

Depending on the exact deployment scenario, the access nodes 120 may be RAN nodes such as NG-RAN nodes. NG-RAN nodes may be gNodeBs, gNBs, that provide NG user plane and control plane protocol terminations towards the UE. The gNBs connected by means of NG interfaces to a 5G Core (5GC), more specifically to an Access and Mobility Management Function, AMF, by means of an NG Control Plane, NG-C, interface and to a User Plane Function, UPF, by means of an NG User Plane, NG-U, interface. The access nodes 120 may be interconnected with each other by means of Xn interfaces 126.

The cellular network 100 could be configured to operate in licensed frequency bands, or unlicensed frequency bands (not least such as: unlicensed bands that rely upon a transmitting device to sense the radio resources/medium before commencing transmission, such as via a Listen Before Talk, LBT, procedure; and a 60 GHz unlicensed band where beamforming may be required in order to achieve required coverage).

The access nodes 120 may be deployed in an NG standalone operation/scenario. The access nodes 120 may be deployed in a NG non-standalone operation/scenario. The access nodes 120 may be deployed in a Carrier Aggregation, CA, operation/scenario. The access nodes 120 may be deployed in a Dual Connectivity, DC, operation/scenario, i.e., Multi Radio Access Technology-Dual Connectivity, MR-DC, or NR-DC. The access nodes 120 may be deployed in a Multi Connectivity, MC, operation/scenario.

In such non-standalone/dual connectivity deployments, the access nodes 120 may be interconnected to each other by means of X2 or Xn interfaces, and connected to an Evolved Packet Core, EPC, by means of an S1 interface or to the 5GC by means of a NG interface.

The terminal nodes 110 are network elements in the network that terminate the user side of the radio link. They are devices allowing access to network services. The terminal nodes 110 may be referred to as User Equipment, UE, mobile terminals or mobile stations. The term ‘User Equipment’ may be used to designate mobile equipment comprising means, such as a smart card, for authentication/encryption etc. such as a Subscriber Identity Module, SIM. A SIM/SIM card can be a memory chip, a module, or a Universal Subscriber Identity Module (USIM).

In some examples, the term ‘User Equipment’ can be used to designate a location/position tag, a hyper/smart tag or a mobile equipment comprising circuitry embedded as part of the user equipment for authentication/encryption such as a software SIM. Terminal node 110 functionalities may be performed also by Mobile Termination, MT, part of an Integrated Access and Backhaul, IAB, node.

The access nodes 120 are network elements in the network responsible for radio transmission and reception in one or more cells 122 to or from the terminal nodes 110. The access nodes 120 are the network termination of a radio link. An access node 120 may be implemented as a single network equipment, or have a split architecture that is disaggregated/distributed over two or more RAN nodes, such as a Central Unit, CU, a Distributed Unit, DU, a Remote Radio Head-end, RRH, using different functional-split architectures and different interfaces.

Where the access node 120 has a disaggregated (split) architecture, the access node 120 may comprise one or more distributed units, gNB-DU, and a centralized unit, gNB-CU (not shown in FIG. 1). The gNB-CU is a logical node configured to host a Radio Resource Connection, RRC, layer and other layers of the access node 120. The gNB-CU controls the operation of one or more gNB-DUs. The gNB-DU is a logical node configured to host Radio Link Control, RLC, protocol layer, Medium Access Control, MAC, layer and Physical, PHY, layer of the access node 120. The gNB-DU may communicate via a dedicated interface (e.g. an F1 interface) to a Radio Resource Control, RRC, layer hosted by the gNB-CU. One gNB-DU may support one or multiple cells 122. The gNB, or a gNB-DU, may host one or more Transmission Reception Points, TRPs. gNB-DU functionalities may be performed also by a DU part of an IAB node.

In the following description, a terminal node 110 may be referred to simply as UE 110. In the following description, the UE has NR-DC capability, i.e. it is capable of operating in an NR-DC mode wherein the UE is simultaneously connected to: a first access node configured to serve as a Master Node, MN; and a second access node configured to serve as a Secondary Node, SN. In this regard, the UE is connected to:
a Primary Cell, PCell, of a Master Cell Group, MCG associated with the MN, and
a Primary Secondary Cell, PSCell of a Secondary Cell Group, SCG, associated with the SN.

In the following description, references to signaling to/from an MN may be understood as corresponding to signaling to/from a cell (e.g. a PCell) of an MCG associated with the MN. Likewise, references to signaling to/from a SN (e.g. a source SN, candidate SN or target SN) may be understood as corresponding to signaling to/from a cell (e.g. a PSCell) of a SCG associated with the SN.

A Master Node, MN, may be defined as a network node that provides control plane connectivity towards the core network. A Master Cell Group, MCG, may be defined as a group of cells associated with the MN. The MCG includes a PCell and may also include one or more SCell(s). The PCell may be defined as the cell for uplink/downlink connection to MN, and/or the cell of the MCG used to initiate initial access to the MN.

A Secondary Node, SN, may be defined as a network node that is providing additional radio resources for the UE but is not the MN. A Secondary Cell Group, SCG, may be defined as a group of cells associated with the SN. The SCG includes a PSCell and may also include one or more SCell(s). The PSCell may be defined as the cell for uplink/downlink connection to SN, and/or the cell of the SCG used to initiate initial access to the SN.

A Conditional Handover, CHO, (i.e. to a prepared candidate cell), may be defined as a handover procedure that is triggered by the UE only when configured execution condition(s) are met for the prepared candidate cell. Condition(s) are pre-configured by MN/network. In 3GPP, a conditional handover execution condition is specified by condExecutionCond within the CondReconfigToAddModList information element within the ConditionalReconfiguration information element within an RRCReconfiguration message. CHO configuration information may comprise configuration information for enabling handover to a primary cell. The CHO configuration information can comprise a handover execution condition for a primary cell and a measurement configuration for configuring measurements for a handover execution condition for the primary cell. Triggering conditional handover to the primary cell is dependent upon the measurements meeting the handover execution condition for the primary cell.

In 3GPP, a RRCReconfiguration message specifies a ConditionalReconfiguration information element which provides the CHO configuration. The ConditionalReconfiguration information element comprises a CondReconfigToAddModList information element. The CondReconfigToAddModList information element comprises condExecutionCond and condRRCReconfig. Handover execution condition(s) for a primary cell are specified by condExecutionCond. The RRCReconfiguration message to be applied when the specified conditions are met is provided by condRRCReconfig.

In Dual Connectivity, DC, a UE has contemporaneous connection to an MN and an SN. This is a mode of operation of a UE in RRC_CONNECTED, configured with a Master Cell Group and a Secondary Cell Group.

Dual Connectivity (DC) configuration information may comprise configuration information for dual connectivity to a primary secondary cell (PSCell). The DC configuration information can comprise an addition condition for a primary secondary cell for dual connectivity with the primary cell and a measurement configuration for configuring measurements for an addition condition for the primary secondary cell for dual connectivity with the primary cell, that is, dual connectivity of the UE with both the primary cell and the primary secondary cell.

Triggering addition of a primary secondary cell for dual connectivity is dependent upon the measurements meeting the addition condition for the primary secondary cell.

In 3GPP, a RRCReconfiguration message specifies a ConditionalReconfiguration information element which provides addition/change conditions for the DC. The ConditionalReconfiguration information element comprises a CondReconfigToAddModList information element. The CondReconfigToAddModList information element comprises condExecutionCond and condRRCReconfig. Addition condition(s) for a primary secondary cell (PSCell) are specified by condExecutionCond. The RRCReconfiguration message to be applied when the specified conditions are met is provided by condRRCReconfig.

In NR-DC deployment, a UE that is initially just connected to an MN may add a SN. In this regard, a PSCell of a SCG may be added. Such a PSCell addition may be performed via a Conditional PSCell Addition, CPA, procedure. A UE simultaneously connected to both an MN and a SN may change the SN, i.e. change from a source SN to a target SN. In this regard, a PSCell of a source SCG may be changed to a target PSCell of a target SCG. Such a PSCell change may be performed via a Conditional PSCell Change, CPC, procedure. In the following description, references to CPA/CPC may be referred to as be referred to as Conditional PSCell Addition and/or Change, CPAC.

Before describing example embodiments in detail, there now follows a brief discussion of conventional CPAC. There also follows a discussion of an enhancement of conventional CPAC, namely Selective Activation of CPAC, S-CPAC.

A CPAC procedure can be considered to be an addition or change of a PSCell that is triggered by a UE when one or more execution conditions are met. The execution condition or conditions can be pre-configured by the MN.

In a CPAC procedure, the UE may receive a conditional reconfiguration message from an MN (i.e. the UE receives a CPAC configuration), which includes a configuration of a target PSCell of a target SCG and an execution condition—the fulfilment of which triggers the addition of/change to a target PSCell. The UE evaluates the execution condition and, upon determining that the execution condition has been fulfilled, the UE applies the configuration of the target PSCell and establishes a connection to the target PSCell, e.g. via performing a random-access channel, RACH, access procedure to the target PSCell.

In 3GPP Rel-17, a UE configured with CPA/CPC configurations (i.e. CPAC configurations) has to release the CPA/CPC configurations upon completing a RACH access procedure to the target PSCell. Hence the UE cannot perform subsequent CPA/CPC without the network reinitiating and reconfiguring CPA/CPC. The need for such re-initiation and reconfiguring of CPA/CPC may increase a delay for a cell change and may also increase signaling overhead in effecting the reconfiguring (in particular in scenarios where there are frequent SCG/SN changes, such as which is likely when the UE operates in Frequency Range 2, FR2).

As part of 3GPP Rel-18, further NR mobility enhancements are being considered. In Work Item Description, WID, RP-223236, it was agreed to specify mechanisms and procedures of NR-DC with ‘Selective Activation’ of SCG via L3 enhancements to allow subsequent SCG change after changing SCG without reconfiguring and reinitiating CPC or CPA.

In RAN2 #119bis-e (October 2022), the following procedure was agreed upon:
Step 1: when an execution condition of a CPC candidate PSCell is met, a UE performs the execution of CPC towards the candidate PSCell.
Step 2: after finishing the PSCell addition or change, the UE does not release the conditional configuration of other candidate PSCells for subsequent CPC, and the UE continues evaluating the execution conditions of other candidate PSCells.
Step 3: When the execution condition of a candidate PSCell is met, the UE performs the execution of CPC towards this (further) candidate PSCell.

The above procedure, providing an enhancement of the conventional CPAC procedure enabling Selective Activation of CPAC, may be referred to herein as S-CPAC.

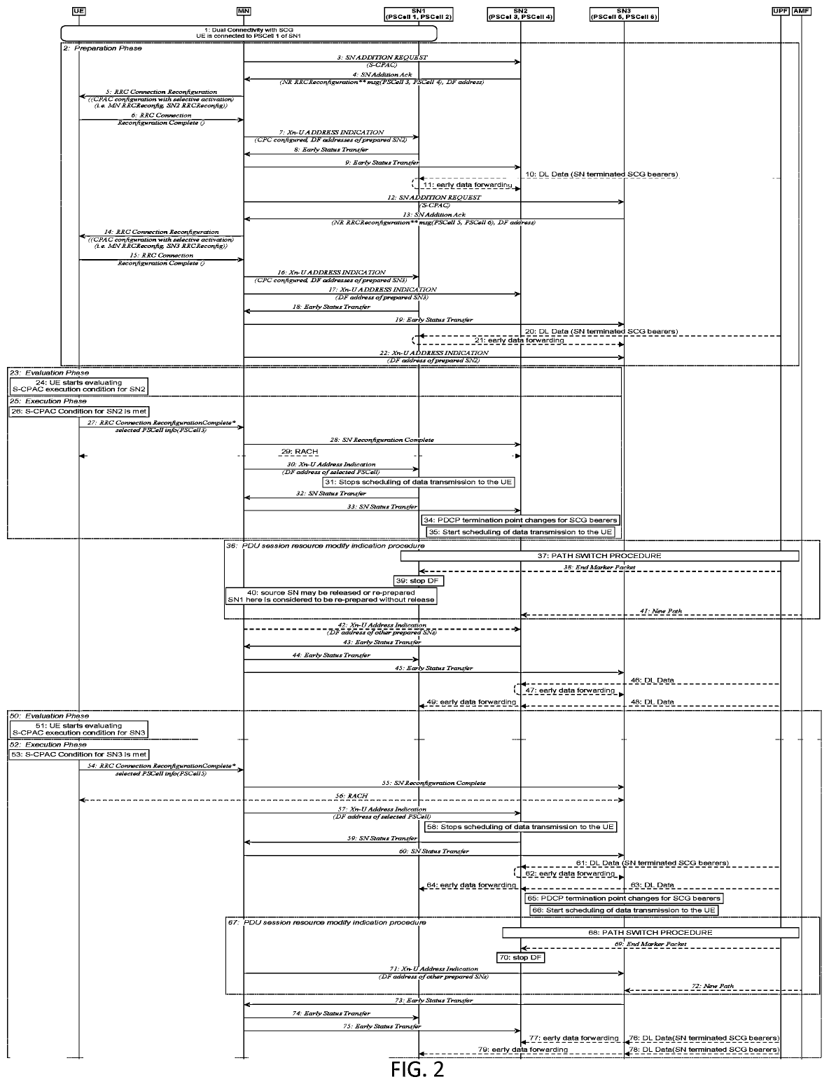

FIG. 2 illustrates a signaling diagram of an example of Selective Activation of Conditional PSCell Addition and/or Change, S-CPAC. In the particular example shown, the method shows two successive S-CPAC executions, wherein the UE changes from a PScell of SN1 to a PScell of SN2, and then changes from the PScell of SN2 to a PScell of SN3.

This figure shows a signaling flow for a typical S-CPAC scenario. In this scenario, the UE is in NR-DC operation and is in an established connected with both a PScell of MN and a PSCell of SN1. The UE is configured with a S-CPAC configuration for a first candidate target SN, namely SN2, and is also configured with a S-CPAC configuration for a second candidate target SN, namely SN3. The UE performs two successive/consecutive S-CPAC executions such that the secondary node changes from SN1 to SN2, and then changes to SN3.

Before describing example embodiments in detail, the problem underlying the present application is described in some more detail.

At high carrier frequencies, e.g., FR2 @28 GHz, Short Stays, SS, and/or Ping-Pong, PP, handovers may be very common mobility events. This can be due to rapid changes in signal power and strong shadow fading impact in FR2 at high frequencies. A cell's coverage area may be penetrated by a neighbouring cell creating a small coverage island for the neighbouring cell within the cell's coverage area. A UE may handover to a neighbouring cell of this coverage islands and handover again, either back to the source cell or to another neighbour cell. This results in a short stay of the UEs in such coverage islands.

Such short stays or ping-pongs are necessary handovers from the UE perspective. This is because preventing such handovers may lead the UE to suffer from strong interference of the cell of the coverage island and may lead interruption on the UE side. This is particularly so for Ultra-Reliable Low Latency Communication, URLLC, UEs, wherein such interruptions would not be acceptable. In a worst case, a UE may experience a radio link failure which leads overall performance degradation of the UE.

A cell border between two cells may show both ‘SS/PP’ characteristics and ‘no SS/PP’ characteristics at the same time. This is because, the cell border is a long area where some regions of the area may have coverage islands and some other regions may not. For instance, considering that such regions could be two streets, UEs in one street may show SS/PP handovers whereas UEs in the other street may not.

Since S-CPAC is considered for SN deployments in FR2, SS/PP handovers may be an issue for in S-CPAC. Moreover, this issue would be more pronounced in S-CPAC since a UE may have plural preparations (for example, with respect to steps 5 and 6 of FIG. 2, a UE may receive an S-CPAC configuration for a first candidate target (SN2) and an S-CPAC configuration for a second candidate target (SN3), and the UE only monitors the executions one after another without requiring L3 reporting and preparation.

In S-CPAC, a UE may change a candidate SN faster than for conventional CPAC. This is because S-CPAC execution may happen in quick succession with a short stay at any given candidate target SN without any further preparation procedure. This would result in frequent 5GC to NG RAN node DL path switches (e.g. as shown with respect to steps 37 and 68 of FIG. 2)

As shown in FIG. 2, when using a conventional S-CPAC procedure, when two successive S-CPAC executions are performed such that the UE changes from accessing SN1 to accessing SN2, and then the UE changes from accessing SN2 to accessing SN3; two path switch procedures are performed (steps 37 and 68 of FIG. 2). Hence, even if the UE were only to have a short stay in SN2 prior to changing to SN3, under the conventional S-CPAC procedure, it would still be required to perform two path switch changes (one in relation to switching path from SN1 to SN2, and another in relation to switching path from SN2 to SN3).

The inventors have appreciated that, for a short stay at a given candidate target SN, changing the DL path at the same rate of S-CPAC execution is undesired. This is because a path switch procedure is an intensive/involved/heavy procedure on the network, which can result in an unnecessary increase in signaling load over N2, N3 and N4 interfaces.

Furthermore, if early data forwarding is enabled, the data forwarding must be re-initiated from a node that hosts DL termination point from 5GC, each time there is a DL termination point change due to a path switch.

Various examples of the present disclosure seek to reduce the amount of 5GC to NG RAN node DL path switches. Various examples of the present disclosure seek to reduce/avoiding too frequent 5GC to NG RAN node DL path switches. Various examples of the present disclosure seek to reduce/avoiding 5GC to NG RAN node DL path switches occurring at the same rate as that of S-CPAC executions, particularly where it is estimated that the UE may merely have a short stays at a target PSCell.

Various examples of the present disclosure propose to delay DL path switch to prevent performing an unwanted heavy path switch procedure where SS or PP is anticipated across a secondary node.

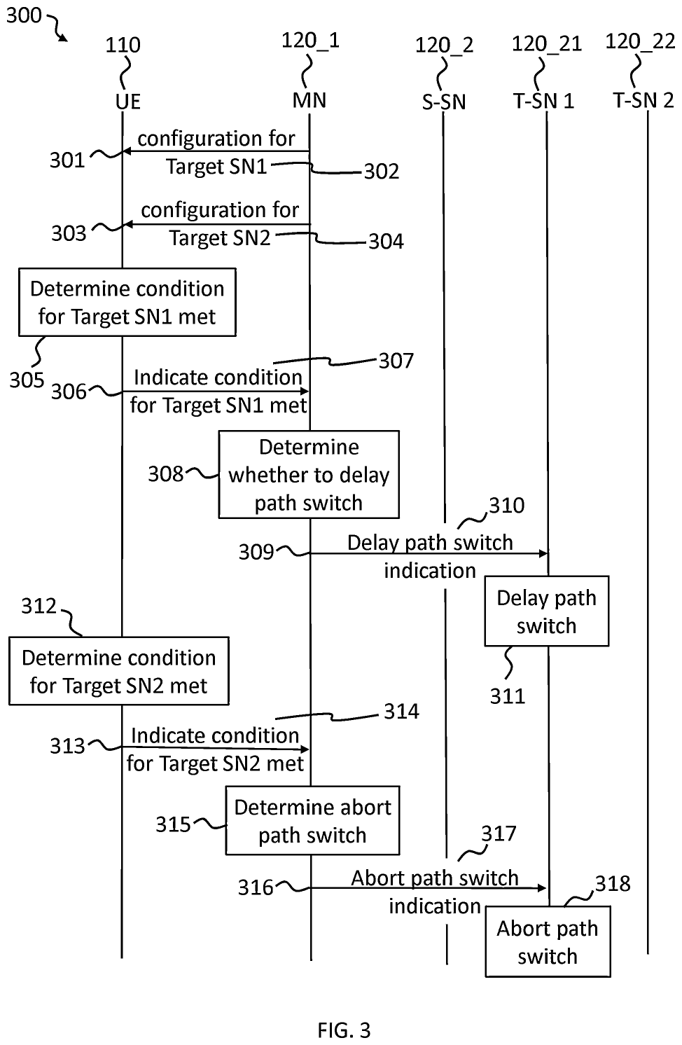

FIG. 3 schematically illustrates an example of a method 300 in accordance with the present disclosure. In the particular example shown, the method is for delaying, and aborting, a path switch procedure in S-CPAC.

In the example of FIG. 3, a plurality of apparatuses/elements transmit and/or receive one or more signals and/or one or more messages across and/or via and/or using a network. In examples, any suitable form of communication in any suitable network can be used. For example, at least a portion of the network 100 of FIG. 1 can be used. Accordingly, in some examples, the plurality of apparatuses/elements in FIG. 2 may form at least a portion of a network 100 as described in relation to FIG. 1. In some but not necessarily all examples, communications and/or transmissions between apparatuses/elements illustrated in FIG. 3 can proceed via any number of intervening elements, including no intervening elements.

In the illustrated example, a UE 110, and four access nodes 120 transmit and/or receive one or more signals and/or one or more messages. In the example of FIG. 3 the four access nodes are: a Master Node MN 120_1, a source Secondary Node S-SN 120_2, and two target SNs: T-SN1 120_21 and T-SN2 120_22. Each of the MN, S-SN and T-SNs may be associated with its own respective cell group. For instance, the MN may be associated with an MCG comprising a PCell and one or more SCells. The S-SN may be associated with a source SCG comprising a source PSCell and one or more source SCells. Each T-SN may be associated with its own respective target PSCell and one or more source SCells.

FIG. 3 can be considered to illustrate a plurality of methods, wherein each method of the plurality of methods is performed by one of the individual apparatuses/elements/entities/actors. In this manner, each such method corresponds to one or more actions by/at a respective apparatus/element/entity/actor, such as one of the: MN, UE, or SNs.

The component blocks of FIG. 3 are functional and the functions described can be performed by a single physical entity (such as is described with reference to FIG. 7. The functions described can also be implemented by a computer program (such as is described with reference to FIG. 8). The blocks illustrated in FIG. 3 can represent actions in a method, functionality performed by an apparatus, and/or sections of instructions/code in the computer program.

Although one UE 120 is illustrated in the example of FIG. 3, in examples any suitable number of UEs can be included. Similarly, in examples, any suitable number of access nodes can be included.

In some but not necessarily all examples, the UE is operating in a Multi Connectivity, MC, mode, such as NR-DC, and is in an established connection with both the MN and S-SN (namely via a PCell of the MSC of the MN and a PSCell of the SCG of the S-SN).

In block 301, the MN sends, to the UE, first conditional re-configuration information 302 for enabling the UE to access a cell of a SCG (e.g. a cell of a SCG associated with T-SN 1) 120_21 upon a first condition being met, wherein the first condition is a condition to access the cell of the SCG.

In block 303, the MN sends, to the UE, second conditional re-configuration information 304 for enabling the UE to access a cell of another SCG (e.g. a cell of a SCG associated with T-SN 2) 120_22 upon a second condition being met, wherein the second condition is a condition to access the cell of the another SCG.

In some but not necessarily all examples, the first and/or second conditional re-configuration information comprises at least one of the following:
CPA configuration information;
CPC configuration information;
CPAC configuration information;
Selective Activation of CPAC, S-CPAC, configuration information; and
CPAC configuration information with selective activation of a Secondary Cell Group, SCG, cell.

In some but not necessarily all examples, the first condition to access the cell of the SCG and/or the second condition to access a cell of another SCG comprises at least one of the following:
a first and/or second execution condition for adding the cell of the SCG and/or the cell of the another SCG respectively;
a first and/or second execution condition for changing to the cell of the SCG and/or the cell of the another SCG respectively; and
a first and/or second execution condition of a CPC candidate PSCell.

In block 305, the UE determines whether the first condition has been met.

In block 306, responsive to determining that the first condition has been met, the UE sends, to the MN, first information 307 indicative that the first condition has been met.

In some but not necessarily all examples, the first information indicating that the first condition has been met comprises an RRC message, not least such as an RRC Connection Reconfiguration complete message.

In block 308, the MN determines whether to delay the cell of the SCG from triggering a path switch.

In block 309, responsive to determining to delay the cell of the SCG from triggering the path switch, the MN sends, to the cell of the SCG, a first indication (310) to delay triggering the path switch. The first indication may be referred to herein as a path switch delay indication.

In some but not necessarily all examples, the first indication is sent via an RRC message, or an SN Reconfiguration complete message.

In block 311, responsive to receiving the path switch delay indication (310), the cell of the SCG delays triggering the path switch. In this regard, the cell of the SCG may comprise means for determining whether to delay triggering the path switch, and determining to delay triggering the path switch may be based at least in part on receiving the delay indication.

In some examples, instead of performing block 308 at the MN, it may be performed at a T-SN (e.g. a cell of a SCG associated with T-SN 1). In such examples, block 309 need not be performed, and block 311's delaying of the triggering of the path switch may be responsive to the cell of the SCG determining to delay triggering the path switch. In some examples, the cell of the SCG may autonomously delay the path switch (i.e. the absence of receiving a delay notification from the MN).

In block 312, the UE determines whether the second condition has been met.

In block 313, responsive to determining that the second condition has been met, the UE sends, to the MN, second information 314 indicative that the second condition has been met.

In block 315, the MN determines whether to abort the cell of the SCG from triggering the path switch.

In some examples, the determination whether to abort triggering the path switch may be based at least in part on when the path switch delay indication 310 was sent and when the second information 314 was received. For instance, the MN may determine to abort the cell of the SCG triggering the path switch if the second information 314 is received within a pre-determined time period from when the path switch delay indication was sent. In this regard, the path switch delay indication may comprise an indication of a delay time, i.e. an amount of time (following a time of receipt of the path switch delay indication) that the cell of the SCG should wait to expire before triggering the path switch. In some examples, if the difference between the time of reception of the second information 314 and the time the path switch delay indication was sent is less than the delay time, then the MN may determine to abort the cell of the SCG triggering the path switch

In block 316, responsive to determining to abort the cell of the SCG triggering the path switch, the MN sends, to the cell of the SCG, a second indication 317 to abort triggering the path switch. The second indication may be referred to herein as a path switch abort indication.

In some but not necessarily all examples, the second indication is sent via at least one of:
an Xn User plane, Xn-U, interface; and
an Xn-U Address Indication message.

In block 318, responsive to receiving the second indication 317 to abort triggering the path switch, the cell of the SCG aborts triggering the path switch. In this regard, the cell of the SCG may comprise means for determining whether to abort triggering the path switch, and determining to abort triggering the path switch may be based at least in part on receiving the abort indication.

The flowchart of FIG. 3 represents one possible scenario among others. The order of the blocks shown is not absolutely required, so in principle, the various blocks can be performed out of order. Not all the blocks are essential. In certain examples one or more blocks can be performed in a different order or overlapping in time, in series or in parallel. One or more blocks can be omitted or added or changed in some combination of ways.

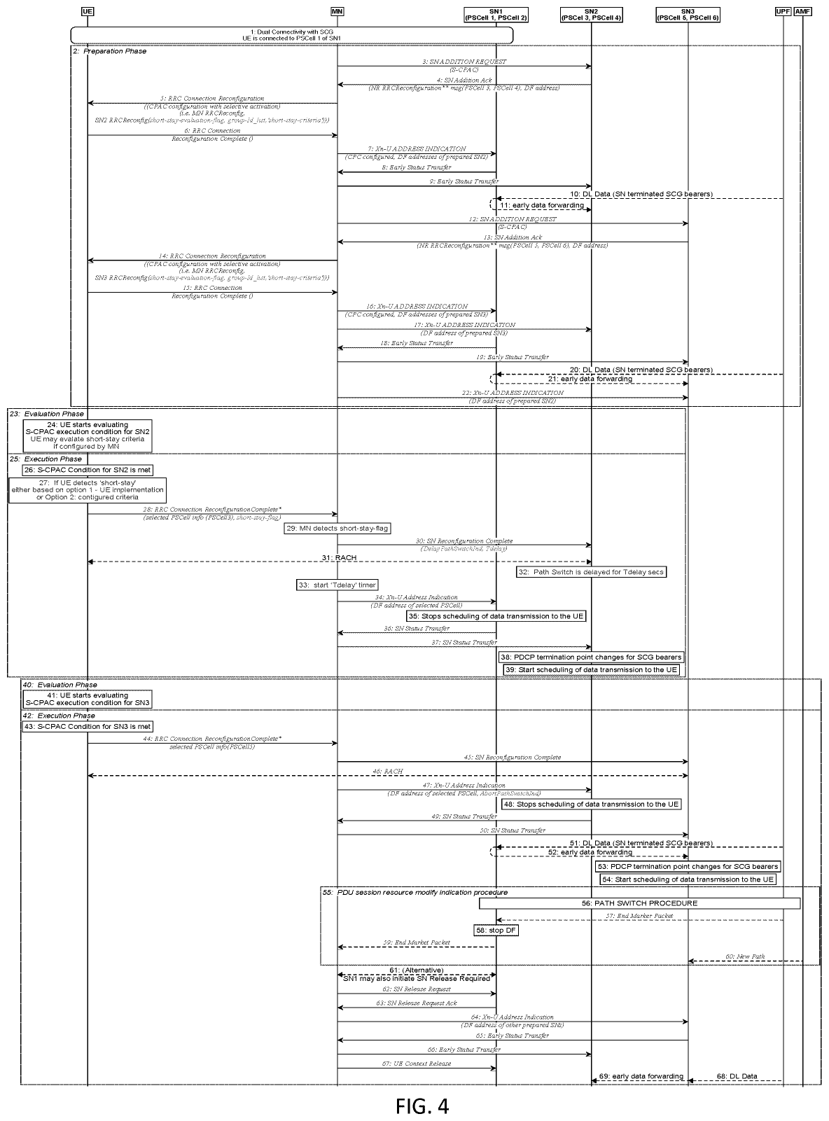

One or more of the features discussed in relation to FIG. 3 can be found in one or more of the other FIGS. 4 to 6.

The manner in which the MN determined whether to initiate a path switch delay procedure (i.e. how the determination is made in block 308, which can cause/lead to the performance of blocks 309 and 311) can be effected not least in accordance with first to third examples embodiments as illustrated with respect to FIGS. 4 to 6).

According to the first example embodiment (which is further discussed and illustrated with respect to FIG. 4), the determination of block 308 as to whether to delay triggering the path switch is based on an indication received from the UE. In this regard, the UE may determine/evaluate a likelihood of whether access, by the UE, to the cell of the SCG is likely to be less than a threshold amount of time, i.e. whether the access is expected to be for a Short Stay, SS, or if a Ping Pong, PP, access is likely. If the UE determines a likelihood of a SS or PP access, it may send an indication of the same to the MN. The MN, based on receiving such a determination, may make a determination to delay triggering the path switch.

In some examples, the indication comprises or consists of a flag. The flag may be sent in a message to the MN, such as an RRC connection reconfiguration complete message that is sent after the UE has determined that the first condition has been met.

In order to determine whether to send the indication, the UE may determine/evaluate at least one of the following:
whether an expected time duration of access, by the UE, to the cell of the SCG is less than a threshold amount of time. The threshold amount of time may be selected so as be indicative of SS or PP;
whether access, by the UE, to the cell of the SCG is expected to be Short Stay, SS, access; and
whether access, by the UE, to the cell of the SCG is expected to be Ping-Pong, PP, access.

The UE may then determine whether to send the indication based on the above-mentioned determination/evaluation.

The MN may send configuration information to the UE that comprises at least one of the following:
an indication for the UE to send, to the MN, the above-mentioned indication;
information for configuring the UE to evaluate the above-mentioned indication;
one or more criteria (e.g. detection criteria or short stay criteria) for use by the UE to evaluate the above-mentioned indication; and
one of more thresholds for use by the UE to evaluate the above-mentioned indication.

Such configuration may be sent to the UE along with, or as part of the first conditional re-configuration information 302 sent in step 301.

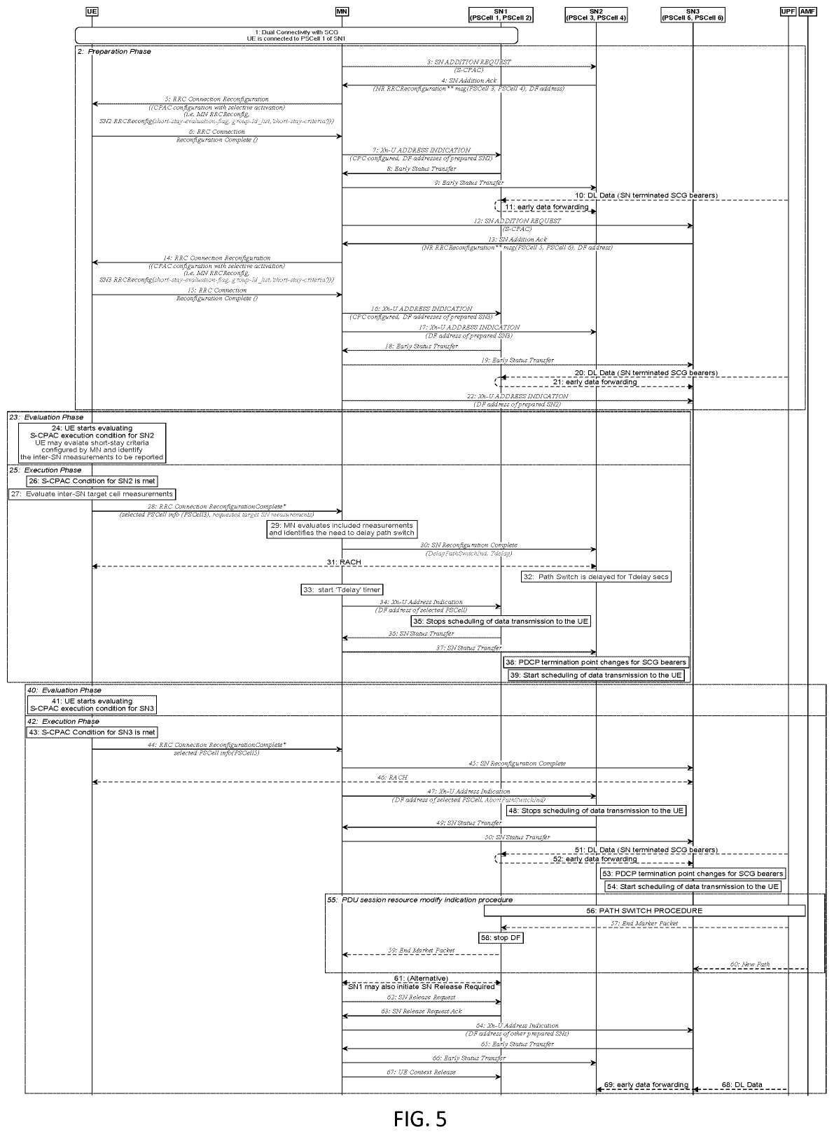

According to a second example embodiment (which is further discussed and illustrated with respect to FIG. 5), the determination of block 308 as to whether to delay triggering the path switch is based on one or more reports of one or more measurements of signals from one or more SNs.

The MN, upon receiving the report(s) of signal measurements from the UE, may determine/evaluate at least one of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

The MN may then determine whether to delay the cell of the SCG from triggering the path switch based on the above-mentioned determination/evaluation.

The UE may send, to the MN, measurements of signals from one or more SNs in at one of the following:
a Radio Resource Control, RRC, message;
a layer 3 measurement report;
an RRC connection reconfiguration complete message; and
a SN RRC reconfiguration complete message; and

The MN may send configuration information to the UE that comprises at least one of the following:
information for configuring the UE to perform and/or report the one or more measurements of signals;
one or more criteria for use by the UE in performing and/or reporting the one or more measurements of signals;
one or more identifiers of one or more cells of the one or more Secondary Cell Groups, SCGs, whose signals are to be measured;
one or more group identifiers of the one or more Secondary Cell Groups, SCGs, whose signals are to be measured;
information for configuring the UE to perform one or more inter Secondary Cell Group, SCG, measurements; and
an indication for the UE to send, to the apparatus, the one or more measurements of signals from one or more SCGs.

Such configuration may be send to the UE along with, or as part of the first conditional re-configuration information 302 sent in step 301.

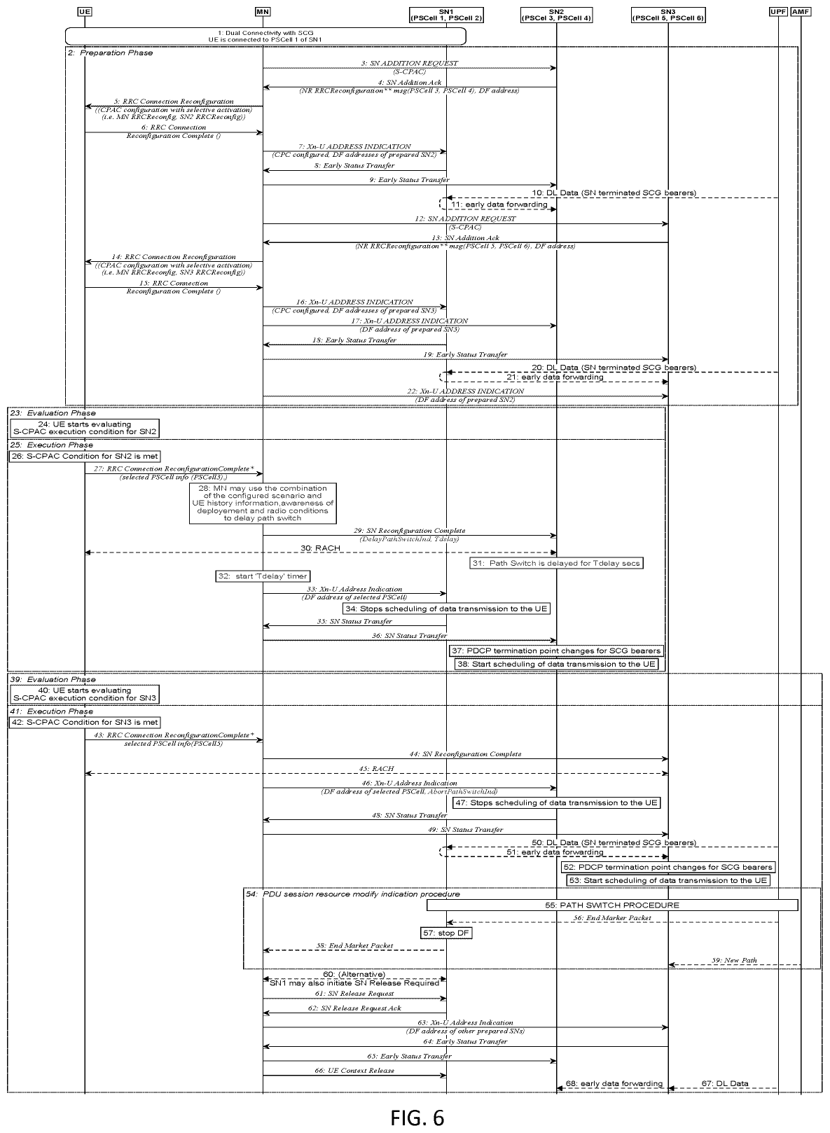

According to a third example embodiment (which is further discussed and illustrated with respect to FIG. 6), the determination of block 308 as to whether to delay triggering the path switch is based on information/knowledge known to the MN, such as at least one of the following:
a configured scenario, for instance knowledge of a configured scenarios may be the MN's awareness S-CPAC (i.e. configuration of selective activation of PSCell) functionality. In some examples, the MN may decide to delay the path switch for every SN change based on knowledge that it is a S-CPAC scenario;
a characteristic of a cell boarder of a RAN node, such a characteristics could be derived jointly or independently based on mobility history information, SON mechanism, or from Operation and Maintenance, O&M (from which cell coverage range and cell boundaries could be identified);
network coverage, cell coverage, and/or a coverage gap.

The MN may evaluate, based at least in part on such information, at least one or more of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

The MN may then determine whether to delay the cell of the SCG from triggering the path switch based on the above-mentioned determination/evaluation.

FIG. 4 illustrates a signaling diagram of an example of S-CPAC, with a path switch delay and abort. This example corresponds to the above-mentioned first example embodiment.

As with the S-CPAC scenario shown in FIG. 2, in the S-CPAC scenario of FIG. 4 there are two successive S-CPAC executions, wherein the UE changes from SN1 to SN2, and then (after a short stay in SN2), the UE changes from SN2 to SN3. However, unlike the S-CPAC procedure of FIG. 2 which necessitates the performance of two path switch changes, advantageously, under the modified S-CPAC procedure of FIG. 4, only one path switch procedure need be performed. This thereby reduces resources, such as signaling overhead, that would otherwise be required to carry out an additional path switch.

Many of the steps and signalling illustrated in FIG. 4 correspond to/are similar to the steps and signalling illustrated in FIG. 2. However, the differences between the two FIGs. comprise the following.

In steps 5 and 14, the MN configures the UE to evaluate short stay detection criteria and thresholds. In some example, a threshold could be a Time-To-Trigger (TTT) value, that the network may configure at the UE, wherein the TTT value is a time for which a criteria for an event trigger holds.

It is noted that the MN's configuration of the UE with S-CPAC configurations for the candidate target secondary nodes (SN2 and SN3) in steps 5 and 14 broadly respectively correspond to blocks 301 and 303 of FIG. 3.

In step 24, the UE evaluates the short-stay criteria configured by MN. This evaluation may occur whilst the UE is also evaluating the S-CPAC execution criteria for the candidate target cell (in this instance SN2).

In step 27, the UE may either use MN configured criteria, e.g. thresholds for target SN cells, or a ‘UE implementation’ specific approach to detect a short stay, i.e. determine whether the change to SN2 is likely to be for a short stay.

In step 28, if the UE detects a short stay/determines a likelihood of short stay, the UE sets a ‘short-stay’ flag in its RRCReconfigurationComplete message that it sends to the MN.

In step 29, the MN detects the ‘short-stay’ flag in the RRCReconfigurationComplete message.

In step 30, responsive to detecting the ‘short-stay’ flag, the MN determines to delay a path switch procedure (such determination broadly corresponding to blocks 308 of FIG. 3), and the MN includes a ‘DelayPathSwitchIndication’ along with a ‘TDelay’ timer value in a ‘SN Reconfiguration Complete’ message. It is noted that step 30 broadly corresponds to block 309 of FIG. 3, and the ‘DelayPathSwitchIndication’ broadly corresponds to the first indication 310 to delay triggering the path switch of FIG. 3.

In step 32, responsive to receiving the ‘DelayPathSwitchIndication’, the target SN (in this instance SN2) delays path switch until an expiry of ‘TDelay’ timer. It is noted that step 32 broadly corresponds to block 311 of FIG. 3.

In step 33, the MN also simultaneously starts ‘TDelay’ timer right after step 30.

In step 41 (similar to step 53 of FIG. 2), UE may start evaluating S-CPAC execution condition for SN3 after step 28.

In step 47, if it is determined that the S-CPAC execution condition for SN3 (of step 43) is met before the expiry of ‘TDelay’ timer, then, after a RACH access procedure (of step 46) to the target cell SN3, the MN signals an ‘AbortPathSwitchIndication’ to SN2 to inform SN2 to abort (i.e. not to trigger) the path switch.

In the first example embodiment illustrated in FIG. 4, the MN's determination as to whether to delay the path Switch procedure may be based on receiving an indication from the UE in RRCReconfigurationComplete message after S-CPAC execution to the target SN.

In a first option, the MN may configure the UE to evaluate potential short stay within the same cell group and report it after S-CPAC execution in RRCReconfigurationComplete. How UE evaluates the short stay may be up to UE implementation. By way of an example, one approach may be for the UE to evaluate how close Reference Signal Received Power, RSRP, values of target cells are compared to the configured event thresholds of a new serving cell including a Time To Trigger, TTT.

In a second option, the MN may configure the UE with a criterion, e.g. thresholds for target SN cells, for a short stay evaluation.

Based on the evaluation using the first or second above-mentioned options, the UE may SET a ‘short-stay’ flag in an ‘RRCReconfigurationComplete’ message after an S-CPAC execution, wherein such a flag indicates the network to delay the Path Switch.

Alternatively, if the UE decides to do additional evaluations considering further/new/fresh radio measurements of target cells against the conditional events of the new serving cell; even in such a case, UE may SET ‘short-stay’ flag in ‘RRCReconfigurationComplete’ message after S-CPAC execution-indicating the network to delay the path switch.

In this case of evaluation of short-stay continuing after S-CPAC, the UE may indicate, via a separate indication, a disabling of short-stay, i.e. if later evaluations conclude that no immediate inter-SN handover is possible. The separate indication may be sent via a MAC CE or RRC message.

FIG. 5 illustrates a signaling diagram of a further example of S-CPAC, with a path switch delay and abort. This example corresponds to the previously mentioned second example embodiment.

As with the S-CPAC scenario shown in FIGS. 2 and 4, in the S-CPAC scenario of FIG. 5 there are two successive S-CPAC executions, wherein the UE changes from SN1 to SN2, and then (after a short stay in SN2), the UE changes from SN2 to SN3. As with the S-CPAC procedure of FIG. 4, the path switch for SN2 can be delayed and, if the change to SN2 is only for a short stay (i.e. within a delay time period), the path switch for SN2 can be aborted—thereby reducing the number of path switch procedures required to be performed and hence reducing the resources/signaling overhead that would otherwise be required to carry out the additional path switch.

Many of the steps and signalling illustrated in FIG. 5 correspond to/are similar to the steps and signalling illustrated in FIG. 2. However, there are the following main differences.

In steps 5 and 14, the MN configures the UE to evaluate short stay detection criteria and thresholds. In this regard the MN may configure the UE to measure and report inter-SN measurements for identified SNs. It is noted that the MN's configuration of the UE with S-CPAC configurations for the candidate target secondary nodes (SN2 and SN3) in steps 5 and 14 broadly respectively correspond to blocks 301 and 303 of FIG. 3.

In step 24, the UE evaluates short-stay criteria configured by MN to identify the inter-SN measurements to the reported. This evaluation may occur whilst the UE is also evaluating the S-CPAC execution criteria for the candidate target cell (in this instance SN2).

In some examples, the UE reports the measurements to the MN via an L3 measurement report when the S-CPAC condition is met.

In some examples, the UE reports the measurements to the MN via an RRCReconfigurationComplete or an SN RRCReconfigurationComplete message.

In some examples, the UE reports the measurements if configured to do so. For instance the UE may reports the measurements if a S-CPAC PP Report is configured to the UE.

In some examples, the UE reports the measurements based on a measurement criteria. Such a measurement criteria may be, for example, a Cell-1 measurement meeting a CPAC condition, and there being second cell, Cell-2, (either serving cell or non-serving cell), that is X dB or less strong (e.g. whose RSRP is X dB less) than Cell-1.

In some examples, the UE reports the measurements if there was another CPAC condition that was partially satisfied but the condition was not fully met, i.e., a time-to-trigger was still running on CPAC-2 condition when CPAC-1 condition was met.

In some examples, the UE makes measurements, measurement comparisons and/or reports only for specific target cells, e.g. if a target cell (i.e. a cell that the UE may go after an initial handover) is under a different SN which can lead path switch.

In step 27, the UE evaluates inter-SN target cell measurements for a configured group-Id (wherein the group-Id is configured in step 5).

In step 28, the UE includes target SN measurements for the configured group-Ids in RRCReconfigurationComplete.

In step 29, the MN evaluates the measurements included in the received RRCReconfigurationComplete message and the MN identifies the potential for short-stay′ (such an identification of the potential for a short stay broadly corresponding to blocks 308 of FIG. 3).

In step 30, responsive to step 29 identifying a potential for a short stay, the MN includes a ‘DelayPathSwitchIndication’ along with a ‘TDelay’ timer value in a ‘SN Reconfiguration Complete’ message.

The remains steps are similar to the steps of FIG. 4

In this regard, in step 32, responsive to receiving the ‘DelayPathSwitchIndication’, the target SN (in this instance SN2) delays path switch until an expiry of ‘TDelay’ timer. It is noted that step 32 broadly corresponds to block 311 of FIG. 3.

In step 33, the MN also simultaneously starts ‘TDelay’ timer right after step 30.

In step 41 (similar to step 53 of FIG. 2), UE may start evaluating S-CPAC execution condition for SN3 after step 28.

In step 47, if it is determined that the S-CPAC execution condition for SN3 (of step 43) is met before the expiry of ‘TDelay’ timer, then, after a RACH access procedure (of step 46) to the target cell SN3, the MN signals an ‘AbortPathSwitchIndication’ to SN2 to inform SN2 to abort (i.e. not to trigger) the path switch.

In the second example embodiment illustrated in FIG. 5, the determination as to whether to delay the path Switch procedure may be based on measurements, included in the UE's ‘RRCReconfigurationComplete’ message, of cells belonging to other candidate SNs that are in close range for consecutive/subsequent conditional execution of S-CPAC.

During target SN preparation for S-CPAC, in the conditional reconfiguration of the UE, the network may configure the UE to include inter-SN target cell measurements for a list of group-Ids for which the network expects the UE to report measurements. For instance, each candidate SN may include a ‘short-stay-evaluation-flag’, ‘List-of-group-Ids-to-be-reported’, ‘short-stay-criteria’.

FIG. 6 illustrates a signaling diagram of a further example of S-CPAC, with a path switch delay and abort. This example corresponds to the previously mentioned second example embodiment.

As with the S-CPAC scenario shown in FIGS. 2 and 4, in the S-CPAC scenario of FIG. 5 there are two successive S-CPAC executions, wherein the UE changes from SN1 to SN2, and then (after a short stay in SN2), the UE changes from SN2 to SN3. As with the S-CPAC procedure of FIG. 4, the path switch for SN2 can be delayed and, if the change to SN2 is only for a short stay (i.e. within a delay time period), the path switch for SN2 can be aborted—thereby reducing the number of path switch procedures required to be performed and hence reducing the resources/signaling overhead that would otherwise be required to carry out the additional path switch.

Many of the steps and signalling illustrated in FIG. 5 correspond to/are similar to the steps and signalling illustrated in FIG. 2. However, there are the following main differences.

In step 28, the MN may use a combination of one or more of:
awareness of configured scenario,
UE mobility history information, and
awareness of radio conditions (e.g. network knowledge of network coverage and coverage gaps)
   to decide whether to delay the path switch.

In step 29, if the MN detects/determines a need to delay path switch, it includes ‘DelayPathSwitchIndication’ and ‘TDelay’ timer in ‘SN Reconfiguration Complete’.

The remains steps 30-68 are similar to steps 31-69 of FIGS. 4 and 5.

In this regard, in step 31, responsive to receiving the ‘DelayPathSwitchIndication’, the target SN (in this instance SN2) delays path switch until an expiry of ‘TDelay’ timer. It is noted that step 31 broadly corresponds to block 311 of FIG. 3.

In step 32, the MN also simultaneously starts ‘TDelay’ timer right after step 30.

In step 40 (similar to step 53 of FIG. 2), UE may start evaluating S-CPAC execution condition for SN3 after step 27.

In step 46, if it is determined that the S-CPAC execution condition for SN3 (of step 42) is met before the expiry of ‘TDelay’ timer, then, after a RACH access procedure (of step 45) to the target cell SN3, the MN signals an ‘AbortPathSwitchIndication’ to SN2 to inform SN2 to abort (i.e. not to trigger) the path switch.

In the first and second example embodiments shown in FIGS. 4 and 5, the MN's determination as to whether to initiate a path switch delay procedure (i.e. determining whether to indicate to/request the target SN2 to delay triggering a path switch) is based on a receiving information from the UE-namely an indication from the UE to delay the path switch (as per FIG. 4) or a report of configured measurements (as per FIG. 5). However, in the third example embodiment, the MN's determination as to whether to initiate a path switch delay procedure is statically made by the MN, i.e. the MN determines whether to initiate a path switch delay procedure based on information already known to the MN without requiring further input/information from the UE.

The first and second example embodiments may be suitable for use in scenarios where both ‘PP/SS’ and ‘no PP/SS’ are observed in a cell border between two cells. In effect, in such situations where it is uncertain whether a ‘PP/SS’ or a ‘no PP/SS’ situation might currently be present/existing, the MN configures the UE to determine and provide information to the MN that enables to MN to determine whether a ‘PP/SS’ or a ‘no PP/SS’ situation might currently be present/existing. In this regard, in the first example embodiment, the MN configures the UE to: determine for itself whether a ‘PP/SS’ or ‘no PP/SS’ situation is currently being observed/is likely, and to indicate the same to the MN (based on which the MN determines whether to initiate a path switch delay procedure). Whereas, in the second example embodiment, the MN configures the UE to measure and report SN signal measurements. The MN then uses such reports to determine whether a ‘PP/SS’ or ‘no PP/SS’ situation is currently being present/is likely (based on which the MN determines whether to initiate a path switch delay procedure).

However, if it is already known to the MN that a cell border has either only ‘PP/SS’ or only ‘no PP/SS’ behaviour, then the MN can avoid configuring UE to ask UE to indicate/report something that is already known by the MN. For instance, if based on historic mobility information (which includes information indicative of whether mobility events/cell changes were SS or PP), the MN is aware that a particular cell border typically has ‘PP/SS’ behaviour, then the MN need not configure a UE, positioned in the particular cell border, to provide the indication/report of the first and second example embodiments.

In the third example embodiment, the MN utilises information already known to the MN, e.g. a priori information not least such as historic mobility information, to determine for itself whether a ‘PP/SS’ or ‘no PP/SS’ situation is likely for a given UE in a given cell boarder.

This may thereby avoid the need to configure the UE to make the evaluations, measurements and reporting of the first and second example embodiment, and hence save resources, not least resources of the UE.

However, in the third example embodiment, the MN may still need to configure the S-SN and T-SN to delay the path switch procedure in case it is needed. Herein, the “needed” refers to the cell border characteristics and the mobility behaviour that is known, i.e. based on previous mobility events (such as via a known method of a Self-Optimising Network, SON, mechanism).

Advantageously, the example embodiments 1 and 2, allow the network (i.e. the MN) to configure the UE with a criterion to evaluate short-stay (or ping pong) conditions and report either a short-stay indication/trigger or inter-SN target cell measurements, wherein the report enables the network to evaluate whether a short-stay (or ping pong) condition is present/likely based on which the network can determine whether to delay path switch.

Advantageously, the example embodiment 3 allows the network (i.e. the MN) to evaluate a combination of UE mobility history information and deployment radio characteristics to determine whether to delay the path switch.

Advantageously, delaying the path switch in consecutive S-CPAC executions involving short-stay may:
reduce unwanted N2, N3, N4 signaling overhead,
enable graceful handling of forwarding, scheduling and buffering of data,
avoids entering into potential indeterminate state, resulting from potential handling of path switch while previous path switch procedure is still ongoing.

It will be understood that each block and combinations of blocks illustrated in FIGS. 3-6, as well as the further functionality described above, can be implemented by various means, such as hardware, firmware, and/or software including one or more computer program instructions. For example, one or more of the functions described above can be performed by a duly configured apparatus (i.e. an apparatus comprising means for performing the above described functionality). One or more of the functions/functionality described above can be embodied by a duly configured computer program (i.e. a computer program comprising computer program instructions which embody the functions/functionality described above and which can be stored by a memory storage device and performed by a processor).

As will be appreciated, any such computer program instructions can be loaded onto a computer or other programmable apparatus (i.e. hardware) to produce a machine, such that the instructions when performed on the programmable apparatus create means for implementing the functions/functionality specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions/functionality specified in the blocks.

Various, but not necessarily all, examples of the present disclosure can take the form of a method, an apparatus, or a computer program. Accordingly, various, but not necessarily all, examples can be implemented in hardware, software or a combination of hardware and software.

Various, but not necessarily all, examples of the present disclosure are described using flowchart illustrations and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e. such that the method can be computer implemented. The computer program instructions can be executed by the processor(s) to cause a series of operational block/steps/actions to be performed by the processor(s) to produce a computer implemented process such that the instructions which execute on the processor(s) provide block/steps for implementing the functions specified in the block or blocks.

Accordingly, the blocks support: combinations of means for performing the specified functions; combinations of actions for performing the specified functions; and computer program instructions/algorithm for performing the specified functions. It will also be understood that each block, and combinations of blocks, can be implemented by special purpose hardware-based systems which perform the specified functions or actions, or combinations of special purpose hardware and computer program instructions.

FIG. 7 schematically illustrates a block diagram of an apparatus 10 for performing the methods, processes, procedures and signalling described in the present disclosure and illustrated in FIGS. 3 to 6. In this regard the apparatus can perform the roles of the MN, UE, or one of the SNs in the methods illustrated and described above. The component blocks of FIG. 7 are functional and the functions described can be performed by a single physical entity.

The apparatus comprises a controller 11, which could be provided within a device, not least such as an MN, 120_1, a UE 110, a first T-SN 120_22 and a second T-SN 120_22.

The controller 11 can be embodied by a computing device, not least such as those mentioned above. In some, but not necessarily all examples, the apparatus can be embodied as a chip, chip set, circuitry or module, i.e. for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc., to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: a radio transceiver, sensors, input/output user interface elements and/or other modules/devices/components for inputting and outputting data/commands).

The memory 13 stores instructions such as a computer program 14 comprising such instructions (e.g. computer program instructions/code) that controls the operation of the apparatus 10 when loaded into the processor 12. The instructions of the computer program 14, provide the logic and routines that enables the apparatus to perform the methods, processes and procedures described in the present disclosure and illustrated in FIGS. 3 to 6. The processor 12 by reading the memory 13 is able to load and execute the computer program 14.

The instructions may be comprised in a computer program, a non-transitory computer readable medium, a computer program product, a machine readable medium. The term “non-transitory,” as used herein, is a limitation of the medium itself (i.e. tangible, not a signal) as opposed to a limitation on data storage persistency (e.g. RAM vs. ROM). In some but not necessarily all examples, the computer program instructions may be distributed over more than one computer program.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in FIGS. 3 to 6. It is contemplated that the functions of these components can be combined in one or more components or performed by other components of equivalent functionality. The description of a function should additionally be considered to also disclose any means suitable for performing that function.

Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example, be a server device, a base station in a mobile cellular telecommunication system, a client device, a mobile cellular telephone, a wireless communications device, a hand-portable electronic device, a location/position tag, a hyper tag etc. The apparatus can be embodied by a computing device, not least such as those mentioned above. However, in some examples, the apparatus can be embodied as a chip, chip set, circuitry or module, i.e. for use in any of the foregoing.

In one example, the apparatus is embodied on a hand held portable electronic device, such as a mobile telephone, mobile communication device, wearable computing device or personal digital assistant, that can additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) broadcast recording/playing), downloading/sending of data functions, image capture function (for example using a (for example in-built) digital camera), and gaming functions, or any combination thereof.

In examples where the apparatus is provided within an MN 120_1, the apparatus comprises: at least one processor 12; and
at least one memory 13 storing instructions that, when executed by the at least one processor 12, cause the apparatus at least to:
   sending, to a User Equipment, UE, first conditional re-configuration information for enabling the UE to access a cell of a Secondary Cell Group, SCG, upon a first condition to access the cell of the SCG being met;
   sending, to the UE, second conditional re-configuration information for enabling the UE to access a cell of another SCG upon a second condition to access the cell of the another SCG being met;
   receiving, from the UE, first information indicating that the first condition has been met;
   determining whether to delay the cell of the SCG triggering a path switch;
   sending, to the cell of the SCG, a first indication to delay triggering the path switch, wherein the first indication is sent based at least in part on the determination;
   receiving, from the UE, second information indicating that the second condition has been met;
   determining whether to abort the cell of the SCG triggering the path switch; and
   sending, to the cell of the SCG, a second indication to abort triggering the path switch, wherein the second indication is sent based at least in part on the determination whether to abort triggering the path switch.

In examples where the apparatus is provided within a UE 110, the apparatus comprises:
at least one processor 12; and
at least one memory 13 storing instructions that, when executed by the at least one processor 12, cause the apparatus at least to:
   receiving, from a cell of a Master Cell Group, MCG, first conditional re-configuration information for enabling the apparatus to access a cell of a Secondary Cell Group, SCG, upon a first condition to access the cell of the SCG being met;
   receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
   receiving, from the cell of the MCG, second conditional re-configuration information for enabling the apparatus to access a cell of another SCG upon a second condition to access the cell of the another SCG being met;
   determining whether the first condition has been met;
   sending, to the cell of the MCG, first information indicating that the first condition has been met;
   evaluating, responsive to receipt of the configuration information, whether to delay triggering the path switch; and
   sending, to the cell of the MCG, and based at least in part on the evaluation, the indication to delay triggering the path switch.

In examples where the apparatus is provided within a UE 110, the apparatus comprises:
at least one processor 12; and
at least one memory 13 storing instructions that, when executed by the at least one processor 12, cause the apparatus at least to:
   receiving, from a cell of a Master Cell Group, MCG, first conditional re-configuration information for enabling the apparatus to access a cell of a Secondary Cell Group, SCG, upon a first condition to access the cell of the SCG being met;
   receiving, from the cell of the MCG, configuration information for configuring the apparatus measure and report one or more measurements of signals from one or more SCGs for use by the cell of the MCG to determine whether to delay the cell of the SCG from triggering a path switch;
   receiving, from the cell of the MCG, second conditional re-configuration information for enabling the apparatus to access a cell of another SCG upon a second condition to access the cell of the another SCG being met;
   determining whether the first condition has been met;
   sending, to the cell of the MCG, first information indicating that the first condition has been met;
   measuring one or more measurements of signals from the one or more SCGs in accordance with the configuration information;
   sending, to the cell of the MCG, the one or more measurements for use by the cell of the MCG to determine whether to delay the cell of the SCG from triggering a path switch.

In examples where the apparatus is provided within a target SN 120_21, the apparatus comprises:
at least one processor 12; and
at least one memory 13 storing instructions that, when executed by the at least one processor 12, cause the apparatus at least to:
   receiving, from a cell of a Master Cell Group, MCG, reconfiguration information for configuring the apparatus as a candidate cell of a Secondary Cell Group, SCG;
   receiving, from the cell of the MCG, information indicative of a User Equipment, UE, selecting the candidate cell of the SCG; and
   determining to delay triggering a path switch;
   delaying the triggering of the path switch, wherein delaying the triggering of the path switch is based at least in part on the determination to delay triggering the path switch;
   determining to abort triggering the path switch; and
   aborting the triggering of the path switch, wherein aborting the triggering of the path switch is based at least in part on the determination to abort triggering the path switch.

According to some examples of the present disclosure, there is provided a system comprising at least one MN 120_1, UE 110 and one or more target SNs 120_21 as described above.

The above described examples find application as enabling components of: tracking systems, automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IoT); Vehicle-to-everything (V2X), virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

FIG. 9, illustrates a computer program 14 which may be conveyed via a delivery mechanism 20. The delivery mechanism 20 can be any suitable delivery mechanism, for example, a machine readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided a computer program comprising instructions, which when executed by an apparatus (MN 120_1), cause the apparatus to perform at least the following or for causing performing at least the following:
sending, to a User Equipment, UE, first conditional re-configuration information for enabling the UE to access a cell of a Secondary Cell Group, SCG, upon a first condition to access the cell of the SCG being met;
sending, to the UE, second conditional re-configuration information for enabling the UE to access a cell of another SCG upon a second condition to access the cell of the another SCG being met;
receiving, from the UE, first information indicating that the first condition has been met;
determining whether to delay the cell of the SCG triggering a path switch;
sending, to the cell of the SCG, a first indication to delay triggering the path switch, wherein the first indication is sent based at least in part on the determination;
receiving, from the UE, second information indicating that the second condition has been met;
determining whether to abort the cell of the SCG triggering the path switch; and
sending, to the cell of the SCG, a second indication to abort triggering the path switch, wherein the second indication is sent based at least in part on the determination whether to abort triggering the path switch.

In certain examples of the present disclosure, there is provided computer program comprising instructions, which when executed by an apparatus (UE 110), cause the apparatus to perform at least the following or for causing performing at least the following:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
evaluating, responsive to receipt of the configuration information, whether to delay triggering the path switch; and
sending, to the cell of the MCG, and based at least in part on the evaluation, the indication to delay triggering the path switch.

In certain examples of the present disclosure, there is provided computer program comprising instructions, which when executed by an apparatus (UE 110), cause the apparatus to perform at least the following or for causing performing at least the following:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus measure and report one or more measurements of signals from one or more SCGs for use by the cell of the MCG to determine whether to delay the cell of the SCG from triggering a path switch;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
measuring one or more measurements of signals from the one or more SCGs in accordance with the configuration information;
sending, to the cell of the MCG, the one or more measurements for use by the cell of the MCG to determine whether to delay the cell of the SCG from triggering a path switch.

In certain examples of the present disclosure, there is provided computer program comprising instructions, which when executed by an apparatus (target SN 120_21), cause the apparatus to perform at least the following or for causing performing at least the following:
receiving, from a cell of a Master Cell Group, MCG, reconfiguration information for configuring the apparatus as a candidate cell of a Secondary Cell Group, SCG;
receiving, from the cell of the MCG, information indicative of a User Equipment, UE, selecting the candidate cell of the SCG; and
determining to delay triggering a path switch;
delaying the triggering of the path switch, wherein delaying the triggering of the path switch is based at least in part on the determination to delay triggering the path switch;
determining to abort triggering the path switch; and
aborting the triggering of the path switch, wherein aborting the triggering of the path switch is based at least in part on the determination to abort triggering the path switch.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

Although specific terms are employed herein, they are used in a generic and descriptive sense only and not for purposes of limitation.

Features described in the preceding description can be used in combinations other than the combinations explicitly described.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e. so as to provide direct or indirect connection/coupling/communication. Any such intervening components can include hardware and/or software components.

As used herein, the term “determine/determining” (and grammatical variants thereof) can include, not least: evaluating, calculating, computing, processing, deriving, measuring, investigating, identifying, looking up (for example, looking up in a table, a database or another data structure), ascertaining and the like. Also, “determining” can include receiving (for example, receiving information), retrieving/accessing (for example, retrieving/accessing data in a memory), obtaining and the like. Also, “determine/determining” can include resolving, selecting, choosing, establishing, inferring and the like.

As used herein, a description of an action should also be considered to disclose enabling, and/or causing, and/or controlling that action. For example, a description of transmitting information should also be considered to disclose enabling, and/or causing, and/or controlling transmitting information. Similarly, for example, a description of an apparatus transmitting information should also be considered to disclose at least one means or controller of the apparatus enabling, and/or causing, and/or controlling the apparatus to transmit the information.”

The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example performing such functionality or functionalities may be caused in an apparatus by a processor that executes instructions stored in a memory of the apparatus.

References to a parameter, or value of a parameter, should be understood to refer to “data indicative of”, “data defining” or “data representative of” the relevant parameter/parameter value if not explicitly stated (unless the context demands otherwise). The data may be in any way indicative of the relevant parameter/parameter value, and may be directly or indirectly indicative thereof.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described. In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

We claim:

1. An apparatus comprising:
at least one processor; and
at least one memory storing instructions that, when executed by the at least one processor, cause the apparatus at least to perform the following:
sending, to a User Equipment, UE, first conditional re-configuration information for enabling the UE to access a cell of a Secondary Cell Group, SCG, upon a first condition to access the cell of the SCG being met;
sending, to the UE, second conditional re-configuration information for enabling the UE to access a cell of another SCG upon a second condition to access the cell of the another SCG being met;
receiving, from the UE, first information indicating that the first condition has been met;
determining whether to delay the cell of the SCG triggering a path switch;
sending, to the cell of the SCG, a first indication to delay triggering the path switch, wherein the first indication is sent based at least in part on the determination;
receiving, from the UE, second information indicating that the second condition has been met;
determining whether to abort the cell of the SCG triggering the path switch; and
sending, to the cell of the SCG, a second indication to abort triggering the path switch, wherein the second indication is sent based at least in part on the determination whether to abort triggering the path switch.

2. The apparatus of claim 1, wherein determining whether to abort triggering the path switch is based at least in part on when the first indication was sent and when the second information was received.

3. The apparatus of claim 1, wherein the first indication comprises an indication of a delay time, and wherein determining whether to abort triggering the path switch is based at least in part on a determination that a difference between the time the first indication was sent and the time the second information was received is less than the delay time.

4. The apparatus of claim 1, configured to receive, from the UE, a third indication to delay triggering the path switch;
wherein the determination whether to delay the cell of the SCG from triggering a path switch is based at least in part on the third indication, and
wherein the third indication is indicative of an evaluation by the UE of at least one of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

5. The apparatus of any previous claim, configured to:
receive, from the UE, one or more measurements of signals from one or more Secondary Cell Groups, wherein the determination whether to delay the cell of the SCG from triggering the path switch is based at least in part on the received one or more measurements; and
evaluate, based at least in part on the one or more measurements of signals, at least one of the following:
whether an expected time duration of access, by the UE, to the cell of the SCG is less than a threshold amount of time;
whether access, by the UE, to the cell of the SCG is expected to be a Short Stay, SS, access; and
whether access, by the UE, to the cell of the SCG is expected to be a Ping-Pong, PP, access.

6. The apparatus of claim 5, wherein the determination whether to delay the cell of the SCG from triggering the path switch is based at least in part on the evaluation.

7. The apparatus of claim 1, wherein the first condition to access the cell of the SCG and/or the second condition to access a cell of another SCG comprises at least one of the following:
a first and/or second execution condition for adding the cell of the SCG and/or the cell of the another SCG respectively;
a first and/or second execution condition for changing to the cell of the SCG and/or the cell of the another SCG respectively; and
a first and/or second execution condition of a CPC candidate PSCell.

8. The apparatus of claim 1, wherein the apparatus is configured as a Master Node, MN, to the UE, wherein the UE is operating in a Multi Connectivity, MC, mode and is in an established connection with the MN and a source Secondary Node, SN.

9. An apparatus comprising:
at least one processor; and
at least one memory storing instructions that, when executed by the at least one processor, cause the apparatus at least to perform the following:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus: to evaluate whether to delay the cell of the SCG triggering a path switch, and to send, to the cell of the Master Cell Group, MCG, an indication to delay triggering the path switch based at least in part on the evaluation;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
evaluating, responsive to receipt of the configuration information, whether to delay triggering the path switch; and
sending, to the cell of the MCG, and based at least in part on the evaluation, the indication to delay triggering the path switch.

10. The apparatus of claim 9, wherein the configuration information further comprises at least one of the following:
one or more criteria for use by the apparatus to evaluate an indication to delay triggering a path switch the indication; and
one of more thresholds for use by the apparatus to evaluate an indication to delay triggering the path switch.

11. The apparatus of claim 9, wherein evaluating whether to delay triggering the path switch is based at least in part on evaluating at least one of the following:
whether an expected time duration of access, by the apparatus, to the cell of the SCG is less than a threshold amount of time;
whether access, by the apparatus, to the cell of the SCG is expected to be a Short Stay, SS, access; and
whether access, by the apparatus, to the cell of the SCG is expected to be a Ping-Pong, PP, access.

12. The apparatus of claim 9, wherein the indication is indicative of an evaluation by the apparatus of at least one of the following:
whether an expected time duration of access, by the apparatus, to the cell of the SCG is less than a threshold amount of time;
whether access, by the apparatus, to the cell of the SCG is expected to be a Short Stay, SS, access; and
whether access, by the apparatus, to the cell of the SCG is expected to be a Ping-Pong, PP, access.

13. The apparatus of claim 9, wherein the indication is at one of the following:
a flag in a message sent to the cell of the Master Cell Group, MCG;
sent in a Radio Resource Control, RRC, message;
sent in an RRC connection reconfiguration complete message; and
sent after the apparatus has determined that the first condition has been met.

14. The apparatus of claim 9, wherein the apparatus is a User Equipment, UE, configured for operation in a Multi Connectivity, MC, mode, and wherein the UE is in an established connection with a Master Node, MN, and a source Secondary Node, SN.

15. An apparatus comprising:
at least one processor; and
at least one memory storing instructions that, when executed by the at least one processor, cause the apparatus at least to perform the following:
receiving, from a cell of a Master Cell Group, MCG, first conditional re-configuration information for enabling the apparatus to access a cell of a Secondary Cell Group, SCG, upon a first condition to access the cell of the SCG being met;
receiving, from the cell of the MCG, configuration information for configuring the apparatus measure and report one or more measurements of signals from one or more SCGs for use by the cell of the MCG to determine whether to delay the cell of the SCG from triggering a path switch;
receiving, from the cell of the MCG, second conditional re-configuration information for enabling the apparatus to access a cell of another SCG upon a second condition to access the cell of the another SCG being met;
determining whether the first condition has been met;
sending, to the cell of the MCG, first information indicating that the first condition has been met;
measuring one or more measurements of signals from the one or more SCGs in accordance with the configuration information;
sending, to the cell of the MCG, the one or more measurements for use by the cell of the MCG to determine whether to delay the cell of the SCG from triggering a path switch.

16. The apparatus of claim 15, wherein the configuration information further comprises at least one of the following:
one or more criteria for use by the apparatus in performing and/or reporting the one or more measurements of signals;
one or more identifiers of one or more cells of one or more Secondary Cell Groups, SCGs, whose signals are to be measured;
one or more group identifiers of the one or more Secondary Cell Groups, SCGs, whose signals are to be measured; and
information for configuring the apparatus to perform and report one or more inter Secondary Cell Group, SCG, measurements.

17. The apparatus of claim 15, wherein the one or more measurements of signals are sent in at one of the following:
a Radio Resource Control, RRC, message;
a layer 3 measurement report;
an RRC connection reconfiguration complete message; and
a SN RRC reconfiguration complete message.

18. The apparatus of claim 15, wherein the apparatus is a User Equipment, UE, configured for operation in a Multi Connectivity, MC, mode, and wherein the UE is in an established connection with a Master Node, MN, and a source Secondary Node, SN.

19. An apparatus comprising:
at least one processor; and
at least one memory storing instructions that, when executed by the at least one processor, cause the apparatus at least to perform the following:
receiving, from a cell of a Master Cell Group, MCG, reconfiguration information for configuring the apparatus as a candidate cell of a Secondary Cell Group, SCG;
receiving, from the cell of the MCG, information indicative of a User Equipment, UE, selecting the candidate cell of the SCG; and
determining to delay triggering a path switch;
delaying the triggering of the path switch, wherein delaying the triggering of the path switch is based at least in part on the determination to delay triggering the path switch;
determining to abort triggering the path switch; and
aborting the triggering of the path switch, wherein aborting the triggering of the path switch is based at least in part on the determination to abort triggering the path switch.

20. The apparatus of claim 19, wherein the apparatus automatically determines to delay triggering the path switch.

21. The apparatus of claim 19, wherein the apparatus is configured as a target Secondary Node, SN, for the UE, wherein the UE is operating in a Multi Connectivity, MC, mode and is in an established connection with a Master Node, MN, and a source SN.
